(19) United States
(12) Patent Application Publication
(10) Pub. No.: US 2024/0389569 A1
(43) Pub. Date: Nov. 28, 2024

(54) INSECT MONITORING DEVICE AND METHOD

(71) Applicant: RAPIDAIM HOLDINGS PTY LTD, Brisbane, Queensland (AU)

(72) Inventors: Nancy SCHELLHORN, Brisbane (AU); Darren MOORE, Brisbane (AU)

(21) Appl. No.: 18/686,288

(22) PCT Filed: Aug. 25, 2022
(86) PCT No.: PCT/AU2022/051033

§ 371 Date: Feb. 23, 2024

(30) Foreign Application Priority Data
Aug. 25, 2021 (AU) 2021221779

(51) Int. Cl. A01M 1/02; A01M 1/04; A01M 1/10

(52) U.S. Cl. CPC A01M 1/026; A01M 1/04; A01M 1/10; A01M 2200/01

(57) ABSTRACT

A method of detecting an insect is provided, the method including steps of allowing the insect to enter a first receptacle; sensing a movement of the insect with a sensor; and allowing the insect to leave the first receptacle. Related devices and systems are also provided.

### FIELD

This invention broadly relates to devices, systems, and methods for insect or arthropod monitoring. In particular, although without limitation, the invention relates to scalable detection and monitoring (including real-time detection and monitoring) of arthropod populations, such as moth pests, beetle pests, true bug pests, and fly pests.

### BACKGROUND

Insect pests are responsible for extensive loss of crop productivity worldwide. Recent estimates suggest that 13% of global production of major cereal crops rice, wheat, and maize is lost to insect pests even after existing control efforts. Still higher losses can occur in crops such as cotton and sugarcane, and in orchard trees.

Moths are a paraphyletic group of insects of the order Lepidoptera that include a caterpillar larval stage and winged adult stage. Moth caterpillars metamorphosise into adult moths via a cocoon stage. Moths are a major crop insect pest, with the larval stage responsible for the vast majority of crop damage by moth pests. By way of example, corn borers (Ostrinia nubilalis) are a major pest of grains particularly maize, yellow rice stem borer (Scirpophaga incertulas) are a major pest of rice, diamondback moth (Plutella xylostella) is one of the most serious pests of brassicaceous crops, and codling moth (Cydia pomonella) causes considerable damage to fruit crops.

The family Noctuidae comprises numerous agricultural pest species of global significance. Cutworms, armyworms, and bollworms devastate numerous vegetable and grain crops such as maize, cotton, sorghum, legumes, wheat and canola crops to name a few. Generally, armyworms and cutworms are known for behavioural patterns of large-scale invasiveness, with larvae often observed to ‘march’ away from sites where food has been consumed in vast numbers. Fall armyworm (Spodoptera frugiperda) is an important armyworm pest that has been widely distributed in North and South America. Over the last few years FAW has invaded many other locations including in Africa, China, and Australia.

Beetles, of the order Coleoptera, are another insect group containing numerous crop pests. As for moths, the beetle larval stage is primarily responsible for agricultural damage, although adult beetles can also feed relatively extensively on crop plants. Exemplary beetle pests of significance to crop production include potato bug (Leptinotarsa decemlineata) and boll weevil (Anthonomus grandis). Corn rootworm (Diabrotica spp.) is another beetle crop pest of major significance, with western corn rootworm (D. virgifera virgifera), northern corn rootworm (D. barberi), and southern corn rootworm (D. undecimpunctata howardi) causing substantial losses to corn production in North America and Europe.

True bugs, of the family Heteroptera, are yet another insect group containing a range of horticulture and crop pests. True bugs pierce tissue and feed on plant juices causing damage and losses. By way of example, brown marmorated stink bug (Halyomorpha halys) and green vegetable bug (Nezara viridula) are globally invasive pests to horticulture and legume crops.

Flies, of the order Diptera, also include numerous crop pest species. For example, Ceratis capitata, known as Mediterranean fruit fly or medfly, is one of the most destructive fruit pests in the worlds. Various fly species, including a range of species sometimes referred to as ‘filth flies’ (e.g. Calliphoridae, Sarcophagidae, and Muscidae species) are also important pests in the context of animal husbandry.

Most current monitoring of pest arthropods and insects is conducted by visiting traps designed to attract and trap arthropods of interest. Typically, such traps are checked by hand and the trapped insect content recorded. This approach is extremely time consuming, provides delayed information, and presents major limitations for scale of insect pest monitoring, especially given the typically high mobility of such pests.

Although automated monitoring has become more prevalent in recent years, there are substantial limitations to existing automated detection and monitoring approaches involving that insect traps. In particular, accumulation of dead insects in traps can cause significant issues for both scalability and real-time detection.

Some existing automated traps take pictures of trapped insects, such as dead insects stuck to a sticky insect trap card at the bottom of the trap interior. Images are typically taken at regular intervals, which can facilitate relatively frequent but not real-time monitoring. Furthermore, such traps can quickly fill with dead insects necessitating frequent visits to exchange insect cards.

Certain other existing devices perform automated detection of insects on entry to a trap, such as by activation of infrared or electrical sensors. Nevertheless, dead insects still accumulate in the trap necessitating site visits to empty and clear the trap and limiting scalability. Existing insect trap arrangements for monitoring of insect pests generally result in death of trapped insects. However, the number of individual pests trapped is typically very small relative to the population of the insect pest in the area being monitored. Accordingly, monitoring using existing pest traps generally has very limited, if any, efficacy in respect of direct insect pest control.

With the preceding in mind, it would be desirable to develop new strategies for monitoring of insect pests. It could be particularly desirable to develop new strategies offering improved scalability for detection. It could also be particularly desirable to develop new approaches offering real-time detection in a highly scalable manner, without the need for frequent visits to trap sites. Furthermore, in at least some circumstances, it would be desirable to develop new strategies facilitating both diagnostics and control of insect pests.

Given the significance of such pests to agriculture, new strategies for monitoring and/or controlling insect pests optimised for one or more of moth pests, beetle pests, true bug, and fly pests may in some circumstances be particularly desirable.

Reference to prior art in the background is not, and should not be taken to be, an admission or acknowledgement that the prior art forms part of the common general knowledge in Australia or in any other country or jurisdiction.

### SUMMARY

A first broad form of the present invention provides a method of detecting an arthropod, the method including steps of allowing the arthropod to enter a first receptacle; and sensing movement of the arthropod with a sensor. The method of the first broad form may include a further step of allowing the arthropod to leave the receptacle. In embodiments, the method of the first broad form is a method of detecting and controlling the arthropod.

A first aspect of the present invention provides a method of detecting an arthropod, the method including steps of allowing the arthropod to enter a first receptacle; sensing a movement of the arthropod with a sensor; and allowing the arthropod to leave the first receptacle.

In embodiments, the method of the first form or first aspect is, or is of, a method of monitoring the arthropod in real time or substantially real time.

Suitably, the arthropod according to the method of the first form or first aspect is an insect. Suitably, the insect is an insect pest. In embodiments, the insect pest is an agricultural insect pest.

In embodiments, the agricultural insect pest is a plant pest. The agricultural insect plant pest may be a pest of a vegetable crop, a fruit crop, a grain crop, a fibre crop, or a cereal crop.

In embodiments, the agricultural insect pest is an animal pest. In embodiments, the agricultural insect animal pest is a pest of an ungulate. In embodiments, the agricultural insect animal pest is a pest of poultry. The agricultural insect animal pest may be a pest of cattle, horses, sheep, goats, or swine. The agricultural insect pest may be of chickens, ducks, or turkeys.

In embodiments, the insect according to the method of the first form or first aspect is an insect of an order selected from Lepidoptera, Coleoptera, Heteroptera, Diptera, and Hemiptera.

In embodiments, the insect according to the method of the first form or first aspect is a moth. In embodiments, the moth is of a family selected from Noctuidae, Crambidae, Pyralidae, or Tortricidae. The moth may be a cutworm, armyworm, or bollworm.

In embodiments, the insect according to the method of the first form or first aspect is a beetle. In embodiments, the beetle is of the genus Diabrotica. The beetle may be a corn rootworm. In embodiments, the corn rootworm is selected from western corn rootworm (Diabrotica virgifera virgifera), northern corn rootworm (Diabrotica barberi), and southern corn rootworm (Diabrotica undecimpunctata howardi).

In embodiments, the insect according to the method of the first form or first aspect is a true bug. In embodiments, the true bug is of a genus selected from Halyomorpha, Nezara, Amblypelta. The true bug may be selected from brown marmorated stink bug (Halyomorpha halys), green vegetable bug (Nezara viridula), and fruit spotting bug (Amblypelta lutescens).

In embodiments, the insect according to the method of the first form or first aspect is a fly. The fly may be a fruit fly. In embodiments, the fruit fly is of a genus selected from Ceratitis, Bactrocera, and Anastrepha. The fruit fly may be selected from Mediterranean fruit fly (Ceratitis capitata), Mexican fruit fly (Anastrepha ludens), and Oriental fruit fly (Bactrocera dorsalis). The fly may be a filth fly. In embodiments, the filth fly is of a family selected from Calliphoridae, Sarcophagidae, and Muscidae. The filth fly may be selected from a blow fly, a flesh fly, and a house fly.

The first receptacle according to the method of the first form or first aspect may be an at least partially enclosed or enclosable receptacle. In embodiments, the receptacle comprises an open or openable entry portion. In embodiments, the receptacle comprises an open or openable exit portion.

The step of sensing movement of the arthropod with the sensor according to the first form or first aspect may include: sensing movement of the arthropod shortly or directly before, during, or shortly or directly after entry to the receptacle; sensing movement of the arthropod shortly or directly before, during, or shortly or directly after exit of the receptacle; and/or sensing movement of the arthropod within the receptacle.

In embodiments, the step of sensing movement of the arthropod with the sensor includes sensing movement of the arthropod shortly or directly before, during, or shortly or directly after exit of the receptacle. In embodiments, the step of sensing movement of the arthropod with the sensor includes sensing movement of the arthropod shortly or directly before or during exit of the receptacle.

In embodiments, the step of sensing movement of the arthropod with the sensor includes sensing movement of the arthropod directly before exit of the receptacle. In embodiments, the step of sensing movement of the arthropod with the sensor includes sensing movement of the arthropod during exit of the receptacle.

In embodiments, the step of sensing movement of the arthropod with the sensor includes sensing movement of the arthropod associated with passage of the arthropod through a restricted space. The restricted space may be an aperture, channel, slot, or gap or the like. In embodiments, the restricted space is a channel. In embodiments, the restricted space is a gap. In embodiments, the step of sensing movement of the arthropod with the sensor includes sensing movement of the arthropod as the arthropod enters, passes through, and/or exits the restricted space.

The movement of the arthropod that is sensed with the sensor according to the method of the first form or first aspect may be any suitable movement. Suitably, the movement that is sensed with the sensor is movement of a part of the arthropod against, over, past, or across the sensor.

Suitably, the movement that is sensed with the sensor is movement of the arthropod's body. In embodiments, the movement is movement of the arthropod's head or head parts, such as mouth parts or antennae or the like. In embodiments, the movement is movement of the arthropod's wings. In embodiments, the movement is movement of the arthropod's legs or leg parts such as tarsi or the like. In embodiments, the movement is movement of the arthropod's ovipositor.

In embodiments, the movement that is sensed with the sensor is movement of the arthropod's abdomen. In embodiments, the movement is movement of the arthropod's thorax. The movement of the arthropod's abdomen or thorax may be a dragging, sliding, gliding, scraping, or hovering of the abdomen or thorax against, over, past, or across the sensor.

In embodiments, the movement that is sensed is movement of the arthropod ventrally against, over, past, or across the sensor. In embodiments, the movement that is sensed is movement of the arthropod dorsally against, over, past, or across the sensor.

In embodiments, the step of sensing movement of the arthropod with the sensor according to the method of the first form or the first aspect is a step of sensing movement of the arthropod with an exchangeable sensor. Suitably, the exchangeable sensor is adapted for detecting a particular arthropod or insect, or group thereof. The method of the first form or first aspect may include a step of exchanging the sensor for detection of a particular arthropod or insect, or group thereof, before or after the step of sensing movement of the arthropod with the sensor.

The method of the first form or first aspect may include a step of attracting the arthropod to the first receptacle. In embodiments, the step of attracting the arthropod to the first receptacle includes attracting the arthropod to the open entry portion of the receptacle.

In embodiments, the step of attracting the arthropod to the receptacle includes attracting the arthropod using a chemical stimulant. The chemical stimulant may be a sex pheromone or a feeding stimulant.

In embodiments, the step of attracting the arthropod to the first receptacle according to the method of the first form or first aspect is a step of attracting the arthropod to the first receptacle with an exchangeable attractant. Suitably, the exchangeable attractant is adapted for attracting a particular arthropod or insect, or group thereof. The method of the first form of first aspect may include a step of exchanging the attractant for attraction of a particular arthropod or insect, or group thereof, before or after the step of attracting the arthropod to the first receptacle.

In embodiments, the step of attracting the arthropod to the receptacle includes attracting the arthropod using a visual stimulant. The visual stimulant may be a colour and/or pattern of the receptacle. In embodiments, the visual stimulant comprises a combination of yellow and white colours. In embodiments, the visual stimulant comprises a combination of yellow, green, and white colours.

The method of the first form or first aspect may include a step of contacting the arthropod with a control agent. Suitably, the control agent is a slow or delayed action control agent. In embodiments, the control agent is a slow action insecticide. In embodiments, the control agent is a biocontrol agent. The biocontrol agent may be a fungal, bacterial, or viral biocontrol agent. The biocontrol agent may be a fungal, bacterial, or viral arthropod pathogen, such as a fungal, bacterial, or viral insect pathogen. The biocontrol agent may be or comprise a siliceous sedimentary rock, such as diatomaceous earth.

In embodiments, the step of contacting the arthropod with a control agent is a step of contacting the arthropod with a control agent for the arthropod. In embodiments including the step of contacting the arthropod with a control agent for the arthropod, suitably, the method includes a step of controlling the arthropod by contacting the arthropod with the control agent.

In embodiments, the step of contacting the arthropod with a control agent is a step of contacting the arthropod with a control agent for an agricultural pest, disease, or pathogen that is not the arthropod. In embodiments including the step of contacting the arthropod with a control agent for an agricultural pest, disease, or pathogen that is not the arthropod, suitably, the method includes a step of controlling the agricultural pest, disease, or pathogen that is not the arthropod with the control agent. In embodiments, the agricultural pest, disease, or pathogen that is not the arthropod is a plant pest, disease, or pathogen. In embodiments, the agricultural pest, disease, or pathogen that is not the arthropod is a fungal plant pathogen.

Suitably, the control agent is located within the first receptacle. In embodiments, movement of the arthropod within the first receptacle brings the arthropod into contact with the control agent. The control agent may be in any suitable form including solid, semi-solid, liquid, or gaseous form. In embodiments, the control agent is in powder or dust form, or the like.

The method of the first form or first aspect may include a step of controlling an arthropod population by contact of the population with the arthropod contacted with the control agent. Suitably, in embodiments wherein the control agent is a biocontrol agent, the step of controlling the population includes infecting the population with the control agent with which the arthropod has been contacted.

The method of the first form or first aspect may include a step of allowing the arthropod to enter a second receptacle. Suitably, the second receptacle is connected to the exit portion of the first receptacle. In embodiments, the method of the first form or first aspect may include a step of trapping the arthropod in the second receptacle.

The method of the first form or first aspect may include a step of monitoring one or more environmental characteristics or climate parameters at a location of the first receptacle. The one or more environmental characteristics may be selected from for example temperature, light, and humidity.

Suitably, the sensor with which movement of the arthropod is sensed according to the method of the first form or first aspect is an electronic sensor. In embodiments, the sensor is a capacitance sensor, such as an electrode capacitance sensor. In embodiments, the sensor is of or connectable to a printed circuit board. In embodiments, the sensor is an exchangeable sensor.

In embodiments, the sensor with which movement of the arthropod is sensed is an arthropod sensor of an electronic device. Suitably, the electronic device is connected or connectable to the first receptacle. In embodiments, the electronic device is removably attachable to the first receptacle. In embodiments, the electronic device is connectable, such as removably attachable, to, or near or adjacent to, the open or openable exit portion of the first receptacle.

Suitably, the step of monitoring environmental characteristic(s) at the location of the first receptacle includes monitoring the environmental characteristic(s) with one or more electronic sensors. Suitably the electronic sensor(s) are environmental sensors of an electronic device. In embodiments, the electronic device comprising the one or more environmental sensors is the electronic device comprising the arthropod sensor.

The method of the first form or first aspect may include a step of transmitting information to a database and/or computing device. In embodiments, the information is transmitted using the electronic device comprising the arthropod sensor and/or the one or more environmental sensors.

In embodiments, the information transmitted to the database and/or computing device relates to movement and/or detection of the arthropod. Suitably, transmission of the information relating to movement and/or detection of the arthropod to the database and/or computing device facilitates real time, or substantially real time, monitoring of the arthropod.

In embodiments, the information transmitted to the database and/or computing device relates to the one or more environmental characteristics at the location of the first receptacle. Suitably, transmission of the information relating to the one or more environmental characteristics at the location of the first receptacle facilitates real time, or substantially real time, monitoring of the one or more environmental characteristics.

The information transmitted to the database and/or computing device may include information relating to a condition of: the first receptacle, the second receptacle, the electronic device, the arthropod sensor, the one or more environmental sensors, the chemical stimulant, and/or the control agent. Suitably, transmission of the information relating to said conditions facilitates real time, or substantially real time monitoring of said conditions.

The information transmitted to the database and/or computing device may include information relating to software associated with the electronic device, the arthropod sensor, and/or the one or more environmental sensors.

The method of the first aspect may include a step of receiving information from a database and/or computing device. In embodiments, the information is received using the electronic device comprising the arthropod sensor and/or the one or more environmental sensors.

In embodiments, the information received from the database and/or computing device relates to movement and/or detection of the arthropod.

In embodiments, the information received from the database and/or computing device relates to the one or more environmental conditions at the location of the first receptacle.

In embodiments, the information received from the database and/or computing device relates to a condition of: the first receptacle, the second receptacle, the electronic device, the arthropod sensor, the one or more environmental sensors, the chemical stimulant, and/or the control agent.

In embodiments, the information received from the database and/or computing device relates to software associated with the electronic device, the arthropod sensor, and/or the one or more environmental sensors.

A second broad form of the invention provides a device for detecting an arthropod, wherein the device comprises or is connectable to a sensor for sensing a movement of the arthropod. Suitably, the device of the second broad form is adapted for use in the method of the first broad form or the first aspect. In embodiments, the device of the second broad form is adapted for delivering a control agent to the arthropod.

A second aspect of the invention provides a device comprising a housing and an arthropod sensor within or connected to the housing, wherein the device is adapted for attachment with a receptacle. In embodiments, the housing of the device is releasably attachable with the receptacle.

In embodiments, the arthropod sensor according to the device of the second form or the second aspect is an insect sensor.

Suitably, the arthropod sensor of the device is adapted to sense movement of the arthropod into, within, or out of the receptacle to which the device is attached. In embodiments, the arthropod sensor is adapted to sense movement of the arthropod as, shortly or directly before, or shortly or directly after the arthropod exits the receptacle to which the device is attached.

Suitably, the arthropod sensor has a sensing surface adapted for sensing movement of the arthropod on, past, or across the sensing surface. In embodiments, the sensing surface is a substantially flat surface.

Suitably, the arthropod sensor of the device of the second aspect is an electronic sensor. In embodiments, the sensor is a capacitance sensor, such as an electrode capacitance sensor. In embodiments, the sensor is a printed circuit board (PCB) sensor.

The arthropod sensor of the device may be any suitable shape. In embodiments, the arthropod sensor and/or the sensing surface thereof is substantially round. In embodiments, the arthropod sensor and/or the sensing surface thereof is substantially polygonal. In embodiments, the arthropod sensor and/or the sensing surface thereof is substantially rectangular. In embodiments, the arthropod sensor and/or the sensing surface thereof is substantially square.

In embodiments, the arthropod sensor of the device of the second aspect is a replaceable or exchangeable arthropod sensor. In embodiments, the housing of the device is adapted to receive a plurality of different arthropod, such as insect, sensors. The plurality of different arthropod sensors may have different sensor structures. The plurality of different arthropod sensors may be optimised for detection of different arthropods or insects or groups thereof and/or different arthropod or insect behaviours.

In embodiments, the exchangeable arthropod sensor of the device of the second aspect is exchangeably connectable to a PCB of the device. The exchangeable sensor may be adapted to be exchanged for detection of particular arthropod or insect types, or groups thereof.

In embodiments wherein the arthropod sensor is an exchangeable sensor, the sensor be of an exchangeable sensor body comprising a sensor portion and a connector portion. The connector portion of the exchangeable sensor body may be adapted for connection with a PCB of the device of the second aspect. The connector portion of the exchangeable sensor body may be a substantially elongated connector arm or the like.

In embodiments wherein the arthropod sensor is an exchangeable sensor, the sensor may be of an exchangeable sensor PCB. Suitably, the exchangeable sensor PCB is connectable to a first, main, or primary PCB of the device of the second aspect.

In embodiments, the receptacle with which the device of the second aspect is adapted for attachment comprises an open or openable exit portion. In embodiments, the arthropod sensor of the device is adapted to sense movement of the arthropod towards, past, or through the exit portion of the receptacle when the device is attached to the receptacle.

The device of the second aspect may be adapted for attachment with the receptacle wherein the arthropod sensor is adjacent or substantially aligned with the exit portion of the receptacle. In embodiments, the housing of the device is adapted for placement substantially within the exit portion of the receptacle. The exit portion of the receptacle may be a gap, void, or slot-like exit portion, wherein the housing of the device is insertable into the exit portion to fill or substantially fill the gap, void, or slot-like exit portion.

The housing of the device of the second aspect may be any suitable shape. In embodiments, the housing is a substantially polygonal housing. In embodiments, the housing, or one or more faces, sides, or ends thereof, is substantially rectangular. In embodiments, the housing, or one or more faces, sides, or ends thereof, is substantially trapezoidal. The housing may have a first or front face; a second or back face; an upper or top end; and a lower or bottom end.

In embodiments, the housing of the device of the second aspect comprises a housing entry; and a housing exit. Suitably, the housing entry and housing exit of the device of the second aspect are adapted to allow passage of the arthropod through the housing of the device of the second aspect.

In embodiments, the housing entry of the device of the second aspect is at or of the second or back face of the housing. In embodiments, the housing entry of the device is at or of the lower or bottom end of the housing. In embodiments, the housing exit of the device of the second aspect is at or of the first or front face of the housing.

In embodiments, the housing of the device of the second aspect comprises an aperture or channel for allowing passage of the arthropod therethrough. The housing entry and/or housing exit may be, be of, or comprise the aperture or channel, or respective entry and/or exit sides or ends thereof.

The aperture or channel of the housing of the second aspect for allowing passage of the arthropod therethrough may be any suitable shape. In embodiments, the aperture or channel is substantially round. In embodiments, the aperture or channel is substantially polygonal. In embodiments, the aperture or channel is substantially rectangular. In embodiments, the aperture or channel is substantially square. In embodiments, the aperture or channel is substantially irregular.

The arthropod sensor of the device of the second aspect, and/or the sensing surface thereof, may be at or towards the housing entry; at or towards the housing exit; or between the housing entry and the housing exit. In embodiments, the sensor and/or sensing surface is at or towards the housing entry. In embodiments, the sensor and/or sensing surface is between the housing entry and the housing exit.

In embodiments, the sensing surface of the arthropod sensor is adjacent or near to the entry side or end of the aperture or channel of the housing for allowing passage of the arthropod therethrough. The sensing surface may be at or near an edge of the entry side or end of the aperture or channel.

In embodiments, the sensing surface of the sensor at least partly borders the entry side or end of the aperture or channel for allowing passage of the arthropod therethrough.

In embodiments, the sensing surface of the sensor is located within the housing of the device. In embodiments wherein the sensing surface is located within the housing of the device, suitably, the sensing surface is located between the housing entry and the housing exit of the housing. In embodiments, the sensor is located between the housing entry of the lower or bottom end of the housing, and the housing exit of the first or front face of the housing.

The housing of the device of the second aspect may comprise a restricted space or gap of a given distance, dimension, or width through which the arthropod or insect passes shortly or directly before, shortly or directly after, or while passing or contacting the sensor.

In embodiments, the restricted space or gap of the housing is, or is of, the aperture or channel of the housing for allowing passage of the arthropod or insect therethrough.

In embodiments, the device of the second aspect comprises a restrictor component, such as a projection, choke, wedge, or block, the restrictor component at least in part forming the restricted space or gap. Suitably, the restrictor component is of or attachable to the housing of the device.

The device of the second aspect may comprise one or more arthropod guides, for guiding movement of the arthropod or insect into and/or out of the housing of the second aspect. Suitably, the one or more arthropod guides are of or attachable to the housing of the device.

In embodiments, the device comprises an entry guide for guiding movement of the arthropod into the housing. The entry guide may be an aperture or channel entry guide, for guiding movement of the arthropod into the aperture or channel of the housing allowing passage of the arthropod therethrough. In embodiments, the entry guide is adapted to bring the arthropod onto, past, or across the surface of the arthropod sensor.

In embodiments, the entry guide comprises a sloped, awning-like, or beak-like body wherein an open lower portion narrows to an upper attachment to the housing. In embodiments, the entry guide (or at least a part thereof) is substantially transparent or translucent.

In embodiments, the device comprises an exit guide for guiding movement of the arthropod out of the housing. The exit guide may be an aperture or channel exit guide, for guiding movement of the arthropod out of the aperture or channel of the housing allowing passage of the arthropod therethrough.

In embodiments, the exit guide comprises a sloped, awning-like, or beak-like body wherein an open lower portion narrows to an upper attachment to the housing. In embodiments, the exit guide (or at least a part thereof) is substantially transparent or translucent.

Suitably, the exit guide of the device of the second aspect is adapted to bring the arthropod away from the receptacle to which the device is attached. In embodiments, the exit guide is adapted to constrain or prevent entry of the arthropod or insect into the receptacle to which the device is attached via the exit guide.

Suitably, the arthropod sensor of the device of the second aspect is at least partially sheltered or protected from at least certain materials and/or environmental conditions.

In embodiments, when attached to the receptacle, the arthropod sensor is at least partially protected from material and/or conditions within the receptacle by the entry guide. The entry guide may protect the sensor from dust and grime etc., including insect material such as moth scales or the like.

In embodiments, the arthropod sensor is at least partially protected from environmental conditions by the exit guide. The exit guide may protect the sensor from precipitation, e.g. rain or snow.

In embodiments, the exit guide of the device of the second aspect is an exchangeable exit guide. Suitably, the exchangeable exit guide is exchangeably connectable with the housing of the device of the second aspect.

In embodiments, the device of the second aspect comprises an exchangeable restrictor component or portion, such as a projection, choke, wedge, or block. Suitably, the exchangeable restrictor component or portion is exchangeably connectable with the housing of the device of the second aspect.

In embodiments, the exchangeable exit guide and the exchangeable restrictor component or portion are of a combined exchangeable exit guide and restrictor component. Suitably, the combined exchangeable exit guide and restrictor component is exchangeably connectable with the housing of the device of the second aspect.

In embodiments, the combined exchangeable exit guide and restrictor component comprises a body comprising a sloped, awning-like, or beak-like guide portion at a first or upper end, the guide portion extending in a first or outwards lateral direction; and a restrictor portion comprising a projection, choke, wedge or block, the restrictor portion extending in a second or inwards lateral direction.

In embodiments, the housing of the device of the second aspect comprises a light component for attracting the arthropod in the receptacle to the housing exit. Suitably, the light component is of the second or back face of the housing.

In embodiments, the light component of the housing of the device is a translucent or substantially transparent window or the like, allowing light, such as ambient light, to enter from outside the housing of the device.

In embodiments, the window or the like of the second or back face of the housing of the device of the second aspect is substantially opposite or across from the housing exit of the housing, wherein light from the housing exit passes through the window into the receptacle to which the device is connected or attached.

The device of the second aspect may comprise one or more further sensors. In embodiments, one or more of the further sensors is an environmental sensor, adapted for sensing an environmental condition. In embodiments, the device comprises a temperature sensor. In embodiments, the device comprises a light sensor. In embodiments, the device comprises a humidity sensor.

The one or more further sensors of the device may be at least partially sheltered or protected from environmental conditions. In embodiments, the further sensor(s) are at least partly protected from direct sunlight, rain, and/or wind.

Suitably, the one or more further sensors are connected to the housing of the device. In embodiments, the housing of the device comprises or is connectable with a further sensor shelter. In embodiments, the further sensor shelter comprises an overhang of or attached to the housing body. In embodiments, the further sensor shelter comprises a depression or concavity of the housing body.

In embodiments, the one or more further sensors of the device comprise a sensor for sensing a condition of: the device, the receptacle to which the device is connected, the arthropod sensor, the one or more environmental sensors, a chemical stimulant for attracting the arthropod, and/or a control agent for controlling the arthropod.

Suitably, the device of the second aspect comprises a power source. In embodiments, the power source comprises a battery, such as a lithium-ion battery. The battery may be a rechargeable battery. Suitably, the battery is located within the housing of the device.

In embodiments, the power source of the device comprises a photovoltaic cell. Suitably, the photovoltaic cell is attached to a surface of the housing of the device. In embodiments wherein the device comprises a sensor shelter comprising an overhang and a power source comprising a photovoltaic cell, the photovoltaic cell may be located on a top surface of the overhang.

Suitably, the device of the second aspect comprises a processor. In embodiments, the processor is adapted to process information for storage and/or transmission to a database and/or computing device. In embodiments, the processor is adapted to process information received from a database and/or computing device. Suitably, the processor is located within the housing of the device.

In embodiments, the device of the second aspect comprises a data transmitter and/or data receiver. The data transmitter and/or receiver may comprise an antenna. Suitably, the transmitter and/or receiver is for wireless data transmission. In embodiments, the transmitter and/or receiver comprises a wireless internet component. The wireless internet component may be a mobile broadband or Internet of Things (IOT) component.

In embodiments, the device of the second aspect comprises a data storage component. The data storage component may comprise a hard drive or a solid-state drive. Suitably, the data storage component is located within the housing of the device.

In embodiments, the device of the second aspect comprises one or more user-interface components.

The one or more user interface components may comprise one or more buttons or the like. The one or more buttons may be for configurating the device between operational modes, such as power on and power off modes and/or standard operation and maintenance modes, or the like. The one or more user interface components may comprise a user interface screen, such as an LCD screen or the like. The user interface screen may be a touchscreen.

The device of the second aspect may comprise, or be connectable to, an arthropod collection receptacle. In embodiments, the arthropod collection receptacle is attachable to the exit guide of the device. Suitably, the arthropod collection receptacle comprises a mechanism for preventing or constraining exit of the arthropod from the receptacle. The mechanism may comprise a substantially U- or S-shaped guide or the like, or a one-way gate or the like. In embodiments, the mechanism is positioned near to the open lower portion of the exit guide when the insect collection receptacle is attached to the exit guide.

A third aspect of the invention provides a device comprising a receptacle, the receptacle comprising: an open or openable arthropod entry portion; and an open or openable arthropod exit portion, wherein the device is adapted for attachment with an arthropod sensor wherein movement of an arthropod towards, past, or through the exit portion of the receptacle is sensed by the arthropod sensor.

The device of the third aspect may be adapted for attachment with the sensor wherein the sensor is adjacent or substantially aligned with the exit portion of the receptacle. The device of the third aspect may be adapted for attachment with the sensor wherein the sensor is substantially within the exit portion of the receptacle.

Suitably, the device of the third aspect is adapted for attachment with the device of the second aspect. In embodiments, the receptacle of the device of the third aspect is adapted for attachment with the housing of the device of the second aspect.

The receptacle of the device of the third aspect may comprise a substantially hollow receptacle body. Suitably, the substantially hollow receptacle body comprises a lower part or bottom; an upper part or top; and one or more side walls extending between the bottom and top.

In embodiments, the top of the receptacle body is removably attachable to the one or more side walls of the receptacle body. In embodiments, the bottom of the receptacle body is removably attachable to the one or more side walls of the receptacle body.

The arthropod entry portion of the device of the third aspect may comprise a sloped funnel leading into the receptacle body. In embodiments, the funnel is at or near the top of the receptacle body. In embodiments, the sloped funnel is substantially centrally located in the top of the receptacle body. In embodiments, the sloped funnel is at or near the bottom of the receptacle body. In embodiments, the sloped funnel is substantially centrally located in the bottom of the receptacle body.

In embodiments of the device of the third aspect, the arthropod entry portion is of the top of the receptacle body. In embodiments wherein the arthropod entry portion is of the top of the receptacle body and the entry portion of the device comprises a sloped funnel leading into the receptacle of the body, suitably, the sloped funnel leads downwards into the receptacle body.

In embodiments of the device of the third aspect, the arthropod entry portion is of the bottom of the receptacle body. In embodiments wherein the arthropod entry portion is of the bottom of the receptacle body and the entry portion of the device comprises a sloped funnel leading into the receptacle of the body, suitably, the sloped funnel leads upwards into the receptacle body.

In embodiments of the device of the third aspect, the arthropod exit portion is of the one or more side walls of the receptacle body. The arthropod exit portion may be of a rearward or back side of the receptacle body. The back side may be a substantially flat back side.

In embodiments, the arthropod exit portion is in the form of a gap, void, or slot in the one or more side walls of the receptacle body, such as in the back side of the receptacle body. Suitably, the gap, void, or slot is adapted to receive a housing comprising the insect sensor, such as the housing of the device of the second aspect. Suitably, the gap, void, or slot is adapted to receive the housing to fill or substantially fill the gap, void, or slot.

In embodiments, the receptacle comprises one or more drainage holes adapted to allow drainage of liquid from the receptacle. In embodiments, the one or more drainage holes are of the bottom of the receptacle. Suitably, the drainage holes are sized to exclude exit of the arthropod from the bottom of the receptacle body.

The device of the third aspect may be shaped, patterned, and/or coloured for arthropod, such as insect, attraction. In embodiments, the receptacle body comprises one or more yellow-coloured portions. In embodiments, the receptacle body comprises one or more white-coloured portions. In embodiments, the receptacle body comprises one or more green-coloured portions. In embodiments, the one or more side walls of the receptacle body are substantially white in colour. In embodiments, the top of the receptacle body is substantially yellow in colour. In embodiments, the bottom of the receptacle body is substantially yellow in colour.

The device of the third aspect may comprise a lid. Suitably, the lid at least partially shelters or protects the receptacle from one or more environmental conditions. In embodiments, the lid constrains or prevents entry of precipitation through the top of the receptacle body or the insect entry portion thereof. The lid may be shaped, patterned, and or coloured for insect attraction. In embodiments, the lid may be substantially green in colour.

Suitably, the lid is connectable or attachable to the receptacle of the device of the third aspect. In embodiments, the lid is adapted for attachment to the housing of the insect sensor when the housing is received in the arthropod exit portion of the receptacle body.

The device of the third aspect may comprise an arthropod attractant portion. Suitably, the arthropod attractant portion is adapted to hold or be impregnated with an arthropod attractant, such as an insect attractant, e.g. chemical insect attractant. The arthropod attractant portion may comprise a partially open or caged body in which an arthropod attractant substance can be placed.

In embodiments of the third aspect, the arthropod attractant portion is attachable to the lid. In embodiments, the arthropod attractant portion is positioned substantially above the sloped funnel of the arthropod entry portion when the lid is connected to the receptacle body of the device. In embodiments, the arthropod attractant portion is insertable into a substantially central aperture or channel of the lid.

In embodiments of the third aspect, the arthropod attractant portion is attachable to the top of the receptacle body. In embodiments, the arthropod attractant portion is positioned substantially above the sloped funnel of the arthropod entry portion. In embodiments, the arthropod attractant portion is insertable into a substantially central aperture or channel of the top of the receptacle body.

The arthropod attractant portion of the device of the third aspect may be a replaceable and/or exchangeable attractant portion. The exchangeable attractant portion may be adapted to be exchanged for attraction of particular arthropods or insects, or groups thereof.

The device of the third aspect may comprise a power component. Suitably, the power component comprises a photovoltaic panel. The photovoltaic panel may be attached to the lid or the receptacle body of the device. In embodiments, the photovoltaic panel is attached to the lid.

A fourth aspect of the invention provides a device comprising: a receptacle comprising an arthropod entry portion and an arthropod exit portion; and a sensor within or adjacent the insect exit portion, wherein the sensor is adapted to sense movement of an arthropod towards, past, or through the arthropod exit portion of the receptacle.

In embodiments of the fourth aspect, the receptacle is of the device of the third aspect and the sensor is of the device of the second aspect.

A fifth aspect of the invention provides a system comprising a device of the second aspect and one or more computing devices, wherein the one or more computing devices are adapted to transmit information to and/or receive information from the device of the second aspect.

In embodiments of the fifth aspect, the computing device(s) is or comprises a mobile computing device, such as a smartphone, tablet, or laptop computer. In embodiments of the fifth aspect, the computing device(s) is or comprises a server. In embodiments, the server is or comprises a cloud server.

The system of the fifth aspect may further comprise a device of the third aspect. Suitably, the housing of the device of the second aspect is connected with the arthropod exit portion of the device of the third aspect.

In embodiments, the system of the fifth aspect comprises a plurality of devices of the second aspect. Suitably, the one or more computing devices are adapted to transmit information and/or receive information from each of the plurality of devices of the second aspect. In embodiments, one or more, or each, of the plurality of devices of the second aspect is connected with a respective device of the third aspect.

A sixth aspect of the invention provides a method of monitoring an arthropod with the system of the fifth aspect, including a step of transmitting information between the device of the second aspect and the one or more computing devices.

Suitably, the step of monitoring the arthropod according to the method of the sixth aspect includes monitoring the arthropod with the computing device(s). Suitably, the step of monitoring the arthropod includes processing data on the movement of the arthropod detected by the arthropod sensor of the device of the second aspect.

In embodiments, the method of the sixth aspect is a method of monitoring the arthropod in real time, or substantially in real time.

A seventh aspect of the invention provides a method of estimating population characteristics of an arthropod with the system of the fifth aspect, including a step of transmitting information between the device of the second aspect and the one or more computing devices.

Suitably, the step of estimating population characteristics of the arthropod according to the method of the seventh aspect includes estimating the population characteristics with the computing device(s). In embodiments, the step of estimating population characteristics includes calculating a number of individuals of the arthropod population that are detected by the arthropod sensor of the device of the second aspect over a specified time period.

In embodiments, the step of transmitting information between the device of the second aspect and the computing device(s) includes transmitting information between a plurality of devices of the second aspect and the computing device(s). In embodiments, the plurality of devices of the second aspect is at least about: 10, 20, 50, 100, or 200 devices of the second aspect.

In embodiments of the method of the seventh aspect including transmitting information between the plurality of devices of the second aspect and the computing device, suitably, the plurality of devices of the second aspect are spatially organised. In embodiments, the plurality of devices of the second aspect are spatially organised in a grid or grid-like arrangement.

In embodiments, the method of the seventh aspect is a method of estimating the population characteristics of the arthropod in real time, or substantially in real time.

An eighth aspect of the invention provides a method of updating the device of the second or fourth aspects, including a step of installing and/or updating software on or for the device.

### BRIEF DESCRIPTION OF THE DRAWINGS

The invention will be described hereinafter with reference to typical embodiments illustrated in the drawings, wherein:

FIG. 1 sets forth an exploded view of an embodiment of a device for monitoring and controlling insect pests, device 1000A. Optional attachments for device 1000A are shown in FIG. 1.

FIG. 2 sets forth a front perspective view of a sensor device 100A forming part of the device of FIG. 1.

FIG. 3 sets forth a front perspective view of the device of FIG. 1.

FIG. 4 sets forth a back perspective view of the device of FIG. 1.

FIG. 5 sets forth a lower front perspective view of the device of FIG. 1.

FIG. 6 sets forth an upper front perspective view of the device of FIG. 1.

FIG. 7 sets forth a front view of the device of FIG. 1.

FIG. 8 sets forth a side view of the device of FIG. 1.

FIG. 9 sets forth a back view of the device of FIG. 1.

FIG. 10 sets forth a top view of the device of FIG. 1.

FIG. 11 sets forth a bottom view of the device of FIG. 1.

FIG. 12 sets forth a cross sectional view of the device of FIG. 1.

FIG. 13 sets forth a lower front perspective view of the device of FIG. 1 comprising optional attachments.

FIG. 14 sets forth a lower rear perspective view of the device of FIG. 1 comprising optional attachments, mounted to a picket 10A.

FIG. 15 sets forth a cross sectional view of the device of FIG. 1 comprising optional attachments.

FIG. 16 sets forth top, left side, right side, and front views of the device of FIG. 1 comprising optional attachments, mounted to a picket 10A.

FIG. 17 sets forth colour front and back perspective views of the device of FIG. 1.

FIG. 18 sets forth colour upper and lower front perspective views of the device of FIG. 1.

FIG. 19 sets forth a colour exploded view of the device of FIG. 1 comprising optional attachments.

FIG. 20 sets forth a schematic view of an insect sensor of the device of FIG. 1.

FIG. 21 sets forth a front view of a printed circuit board comprising an insect sensor of the device of FIG. 1.

FIG. 22 sets forth schematic views of alternative insect sensors according to embodiments of the invention.

FIG. 23 sets forth a lower front perspective view of another embodiment of a device for monitoring and controlling insect pests, device 2000.

FIG. 24 sets forth an upper front perspective view of the device of FIG. 23.

FIG. 25 sets forth a cross-sectional view of the device of FIG. 23.

FIG. 26 sets forth a front perspective view of the device of FIG. 23.

FIG. 27 sets forth a rear perspective view of the device of FIG. 23.

FIG. 28 sets forth a lower rear perspective view of the device of FIG. 23 comprising optional attachments, mounted to a picket 10A.

FIG. 29 sets forth colour front and back perspective views of the device of FIG. 23.

FIG. 30 sets forth colour upper and lower front perspective views of the device of FIG. 23.

FIG. 31 sets forth a colour perspective view of a translucent embodiment of an insect trap attachment for the device of FIG. 1 or FIG. 23.

FIG. 32 sets forth an exploded view of another embodiment of a device for monitoring and controlling insects, device 10001B. Optional attachments for device 10001B are shown in FIG. 32.

FIG. 33 sets forth a front view of the device of FIG. 32.

FIG. 34 sets forth a side view of the device of FIG. 32.

FIG. 35 sets forth a back view of the device of FIG. 32.

FIG. 36 sets forth a top view of the device of FIG. 32.

FIG. 37 sets forth a bottom view of the device of FIG. 32.

FIG. 38 sets forth a cross-sectional view of the device of FIG. 32.

FIG. 39 sets forth (A) a front side perspective view of the device of FIG. 32; (B) a back side perspective view of the device of FIG. 32; (C) a lower perspective view of the device of FIG. 32; (D) an upper perspective view of the device of FIG. 32.

FIG. 40 sets forth (A) a lower side perspective view of the device of FIG. 32 with mount 600B removed; (B) a lower side perspective view of the device of FIG. 32 with mount 600B attached to picket 10B.

FIG. 41 sets forth a front view of the device of FIG. 32 showing sensor device 1001B with combined exchangeable exit guide and restrictor 118B removed.

FIG. 42 sets forth (A) a front perspective view of combined exchangeable exit guide and restrictor 118B; (B) a front view of combined exchangeable exit guide and restrictor 118B; (C) a longitudinal sectional view of combined exchangeable exit guide and restrictor 118B showing a first restrictor size; (D) a longitudinal sectional view of combined exchangeable exit guide and restrictor 118B showing a second restrictor size.

FIG. 43 sets forth (A) a front view of housing 110B of sensor device 1001B; (B) a front view of housing 110B of sensor device 1001B with front panel removed exposing printed circuit board (PCB) and exchangeable PCB sensor; (C) a rear view of housing 110B of sensor device 100B; (D) a rear view of housing 110B of sensor 100B with rear panel removed exposing printed circuit board and exchangeable PCB sensor.

FIG. 44 sets forth a front view of an embodiment of an exchangeable PCB sensor for sensor device 100B.

FIG. 45 sets forth a front view of another embodiment of an exchangeable PCT sensor for sensor device 100B.

FIG. 46 sets forth additional embodiments of sensing surfaces of exchangeable PCT sensors for sensor device 100B.

FIG. 47 sets forth a colour exploded view of the device of FIGS. 32, with optional attachments.

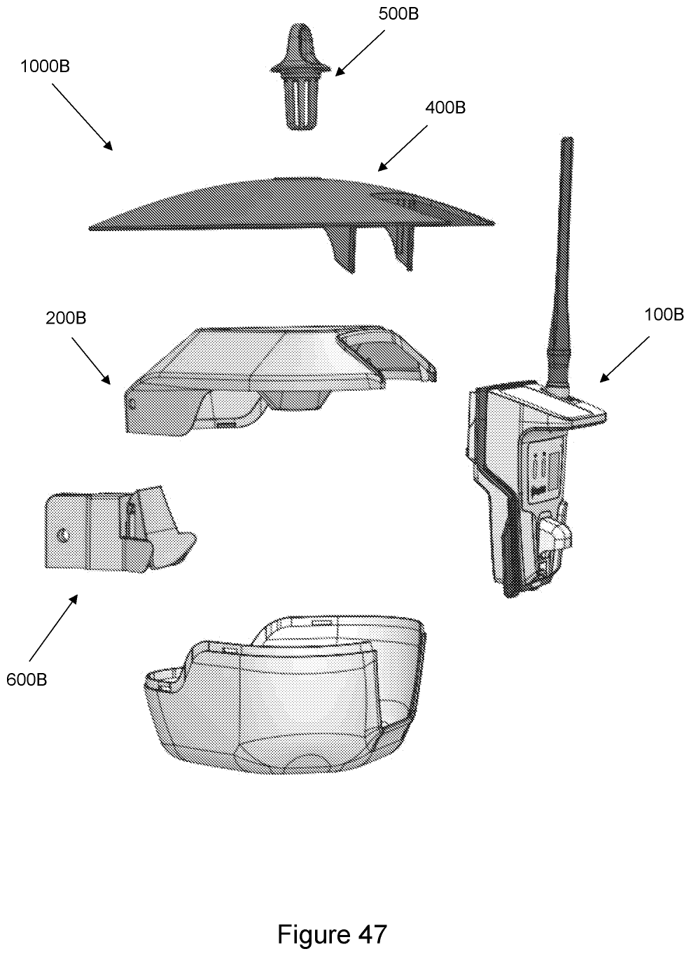

FIG. 48 sets forth (A) a colour front side perspective view of the device of FIG. 32; (B) a colour rear side perspective view of the device of FIG. 32; (C) a colour lower perspective view of the device of FIG. 32; (D) a colour upper perspective view of the device of FIG. 32.

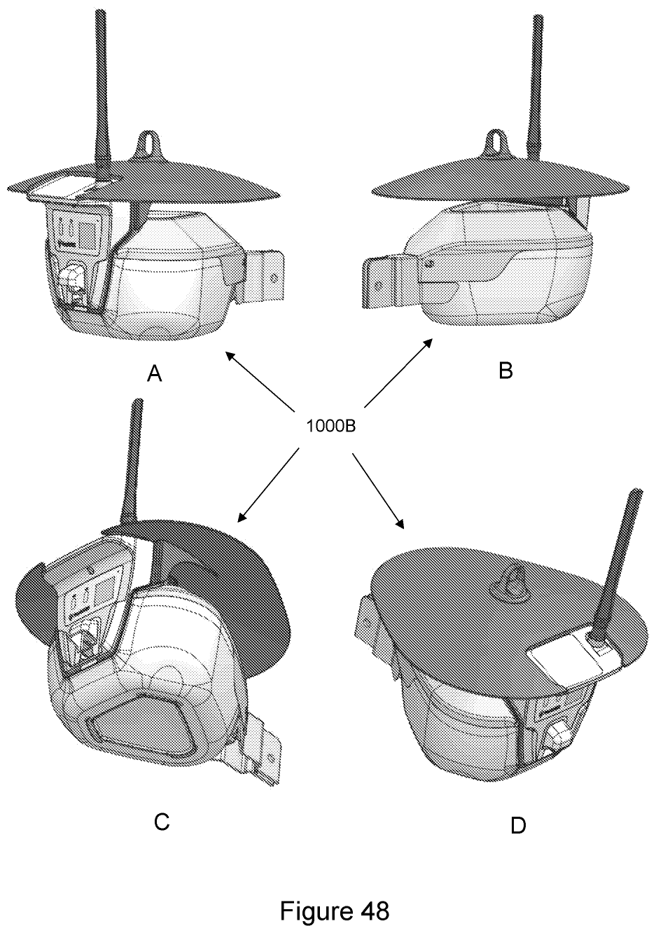

FIG. 49 sets forth (A) a colour rear view of housing 110B of sensor device 100B; (B) a colour front view of housing 110B of sensor 100B.

### DESCRIPTION OF EMBODIMENTS

The present invention is at least partly predicated on the realisation by the applicant that monitoring of arthropods without the need for trapping could offer benefits in terms of efficiency and/or scalability. More particularly, it has been realised that arthropod monitoring approaches involving release or escape of arthropods, rather than trapping or containment, could substantially reduce efforts involved in device maintenance, such as travelling to the site of arthropod traps for emptying, cleaning, or trap component replacement.

Furthermore, the applicant has determined that certain behavioural patterns, such as movements, of arthropods during exit or escape of receptacles, or the like, can be highly effective for arthropod identification. Aspects of the invention are at least partly predicated on this determination. In this context it has been further determined by the applicant that passage of an arthropod through a restricted space or area can, in at least some instances, assist with encouraging certain characteristic behavioural patterns such as movements.

It has also been realised by the applicant that monitoring arrangements wherein arthropods are released or allowed to escape after detection provide potential advantages for combined pest monitoring and control. More particularly, the applicant has realised that arrangements wherein arthropods are released allow for contact of arthropods with control agents at or near the time of detection and prior to release. It has been further realised that, where such control agents can be passed within a population of arthropods (e.g. wherein biological control agents are used) this can allow for combined detection and control of arthropod populations, which may be substantially more efficacious than any control effect of trapping per se.

With the preceding in mind, embodiments of devices for monitoring and controlling insect pests are herein described. Primary reference is made herein to two embodiments, device 1000A and device 1000B, and components 100A/100B, 200A/200B, 300A/300B, 400A/400B, 500A/500B, and 600A/600B. To avoid doubt, it will be appreciated that general reference to device 1000A and device 1000B and components 100A/100B, 200A/200B, 300A/300B, 400A/400B, 500A/500B, and 600A/600B, and to parts thereof, may be made without the use of the ‘A’ and ‘B’ distinction, e.g. 1000 (encompassing 1000A/1000B), 100 (encompassing 100A/100B), 200 (encompassing 200A/200B), 300 (encompassing 300A/300B), 400 (encompassing 400A/400B), 500 (encompassing 500A/500B), and 600 (encompassing 600A/600B) and the like.

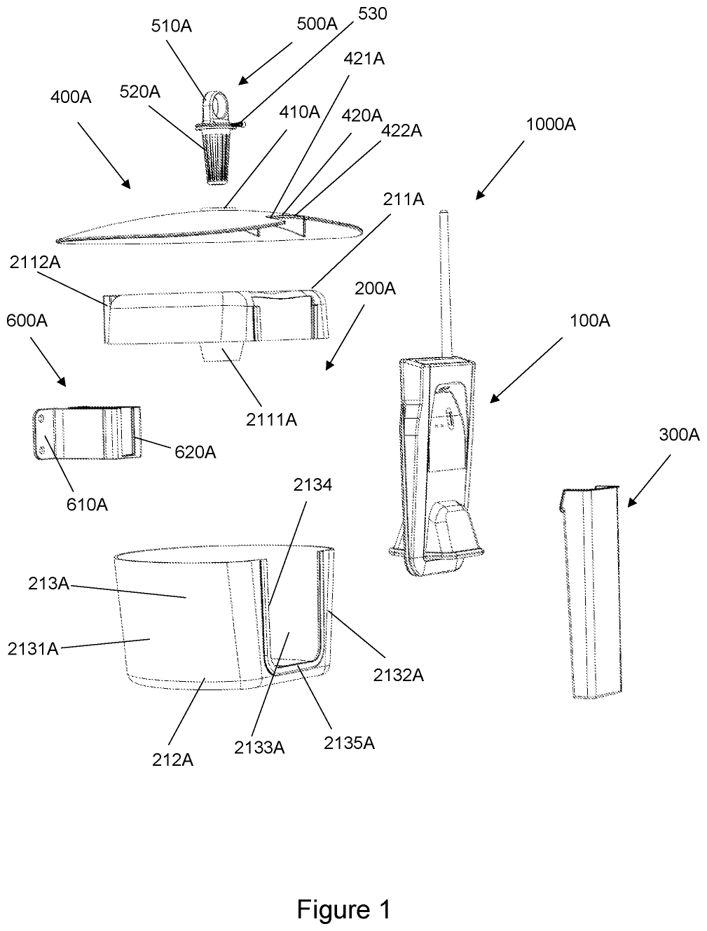

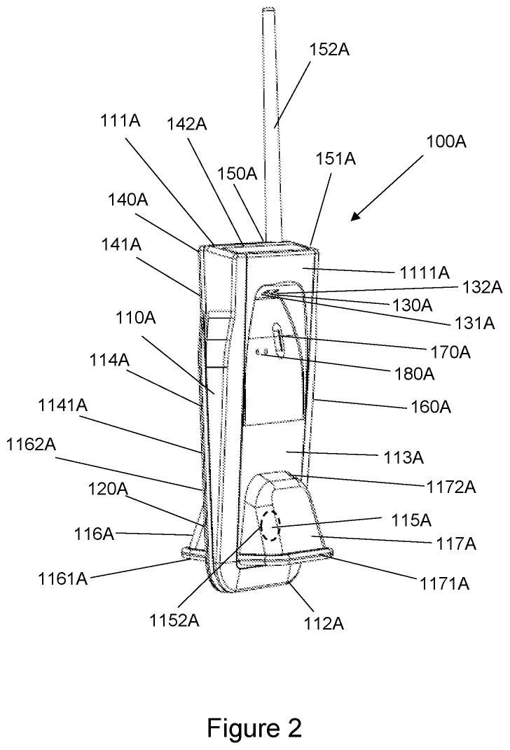

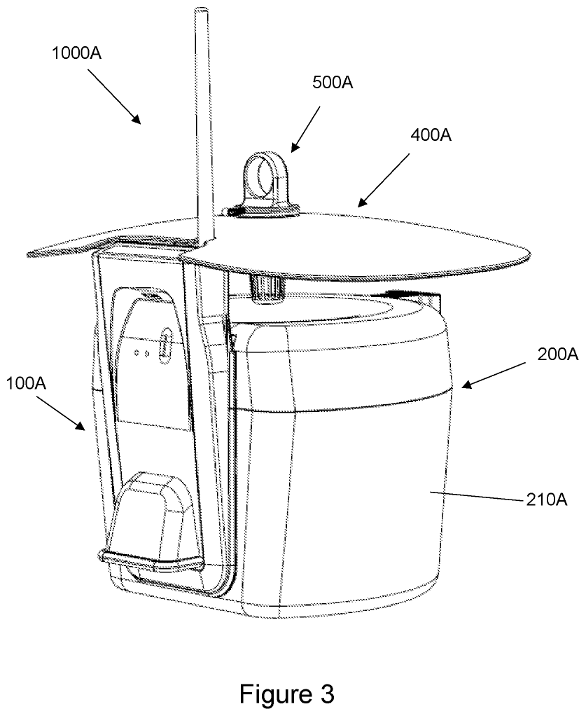

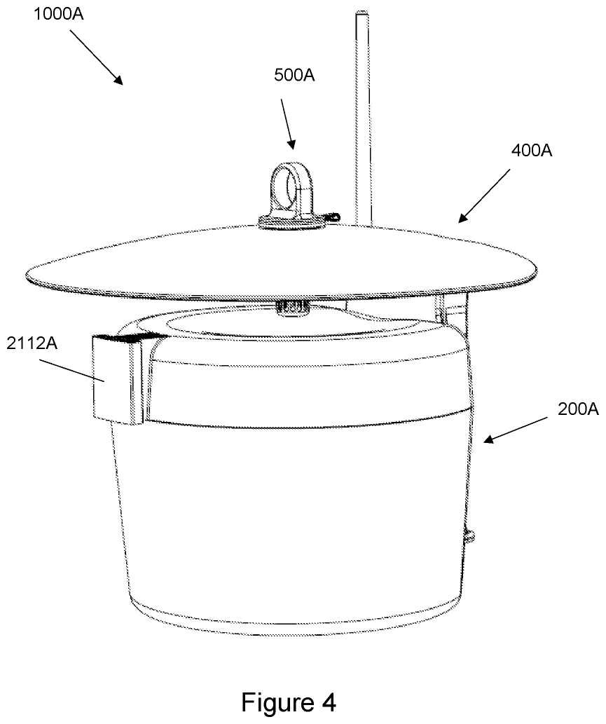

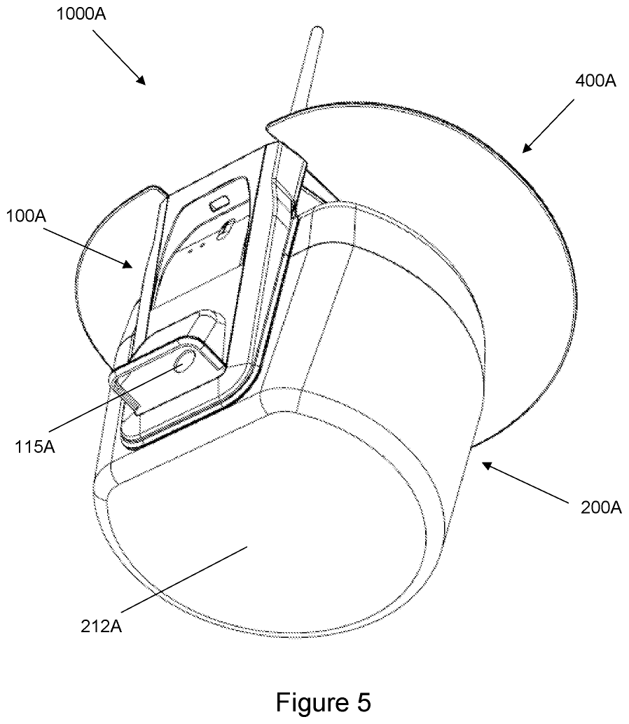

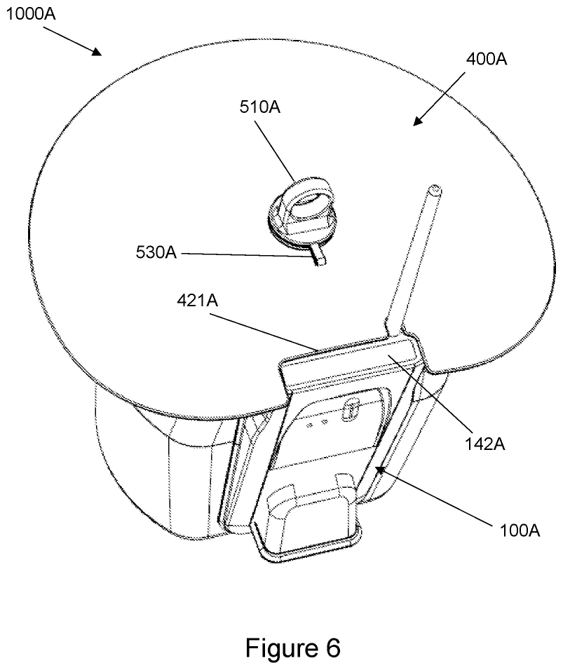

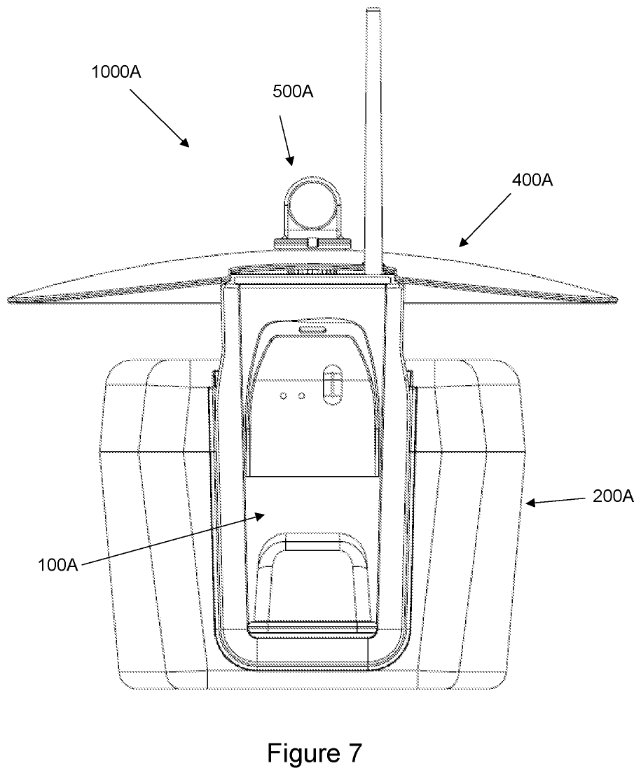

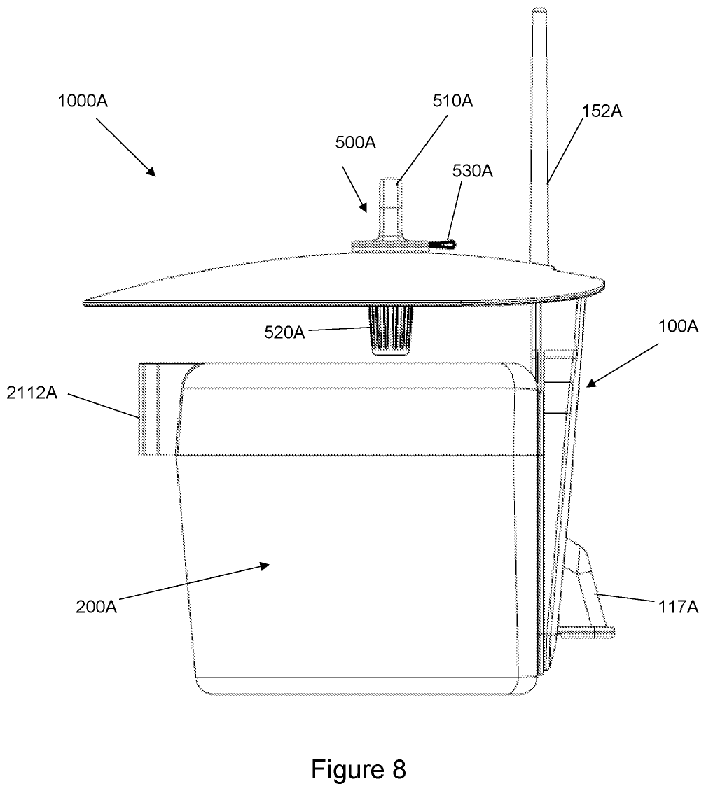

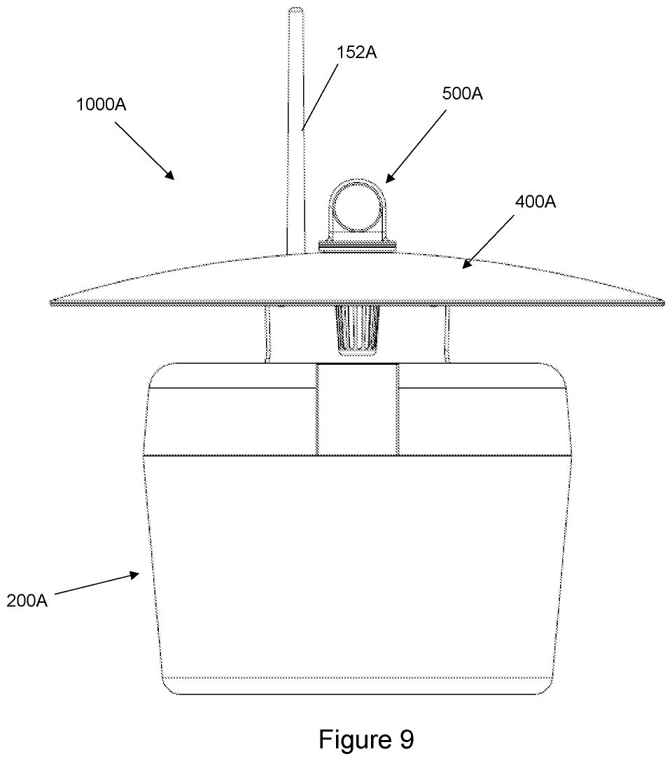

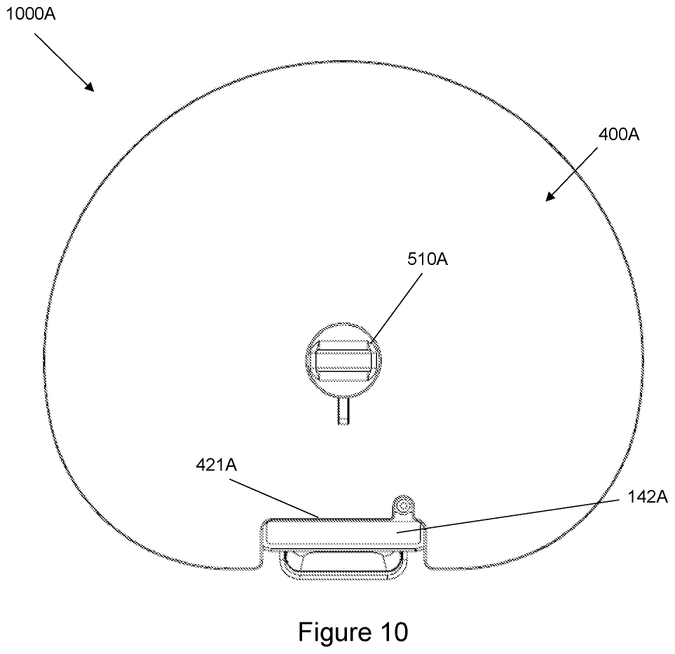

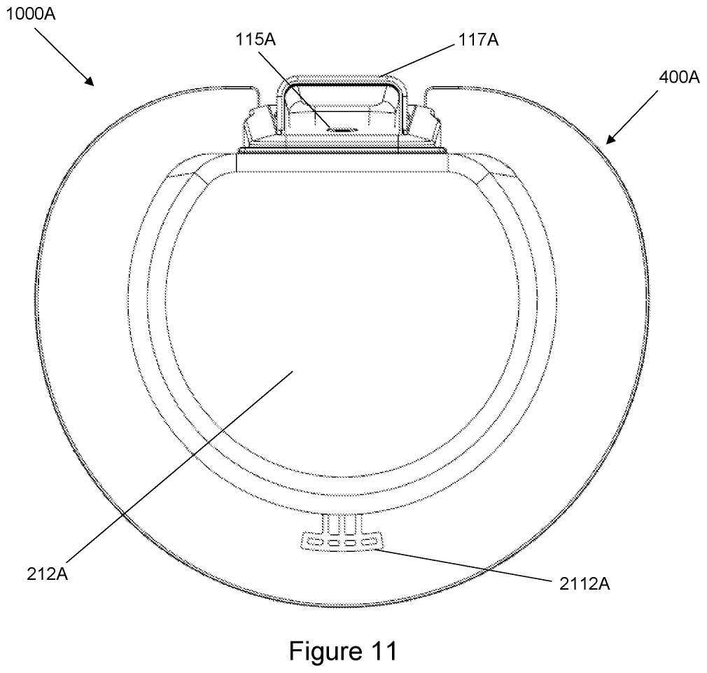

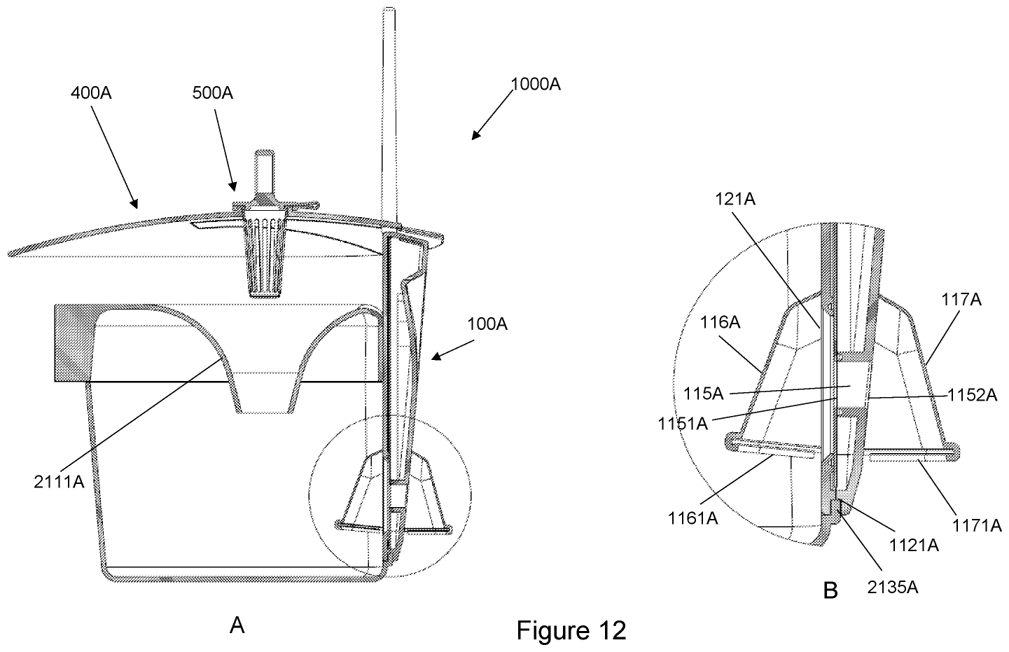

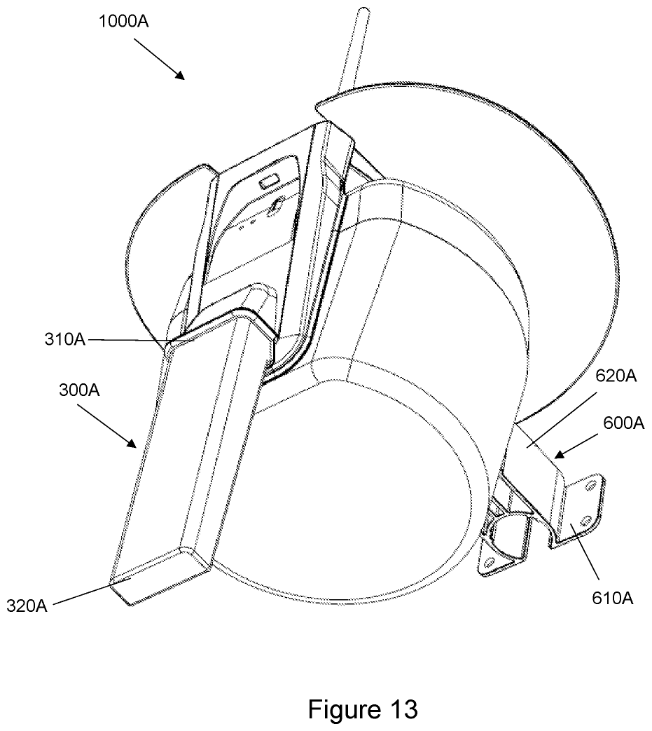

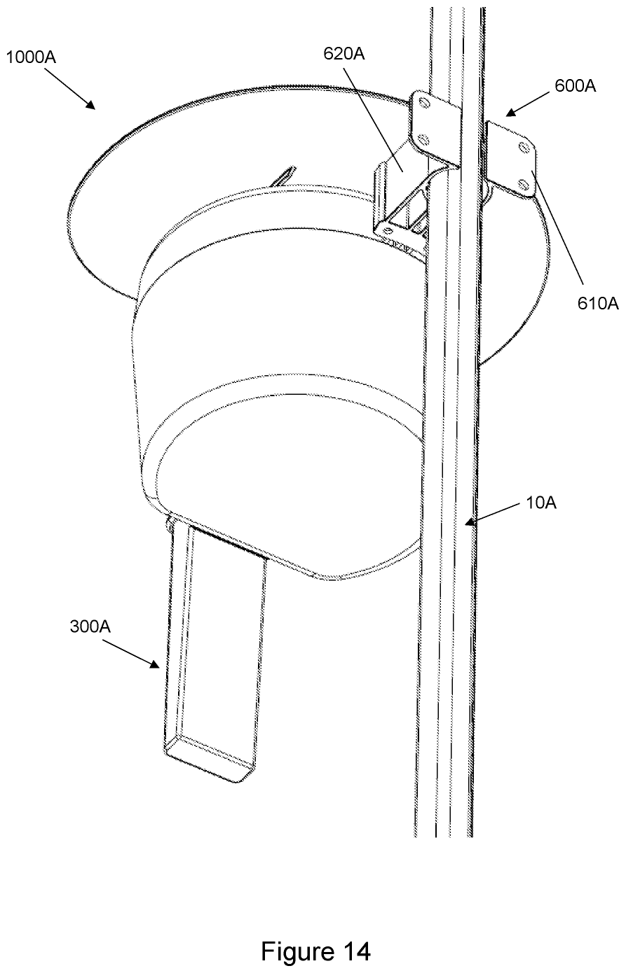

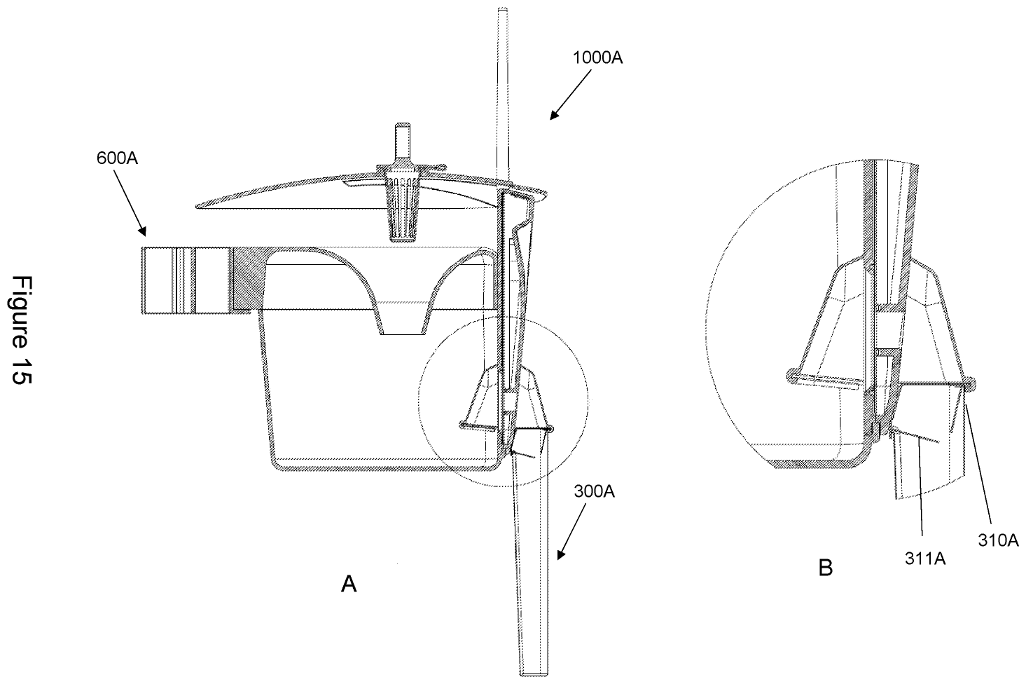

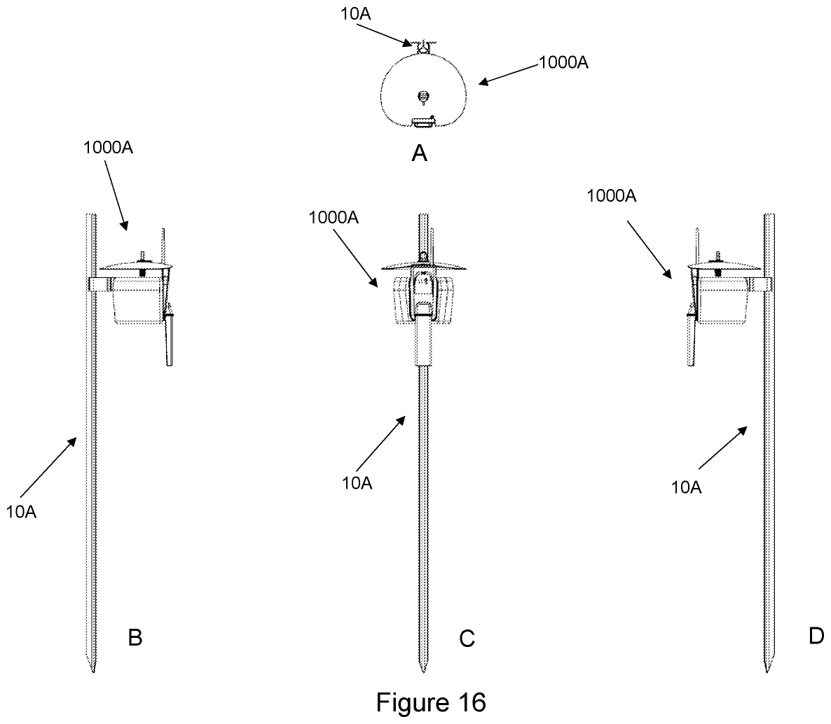

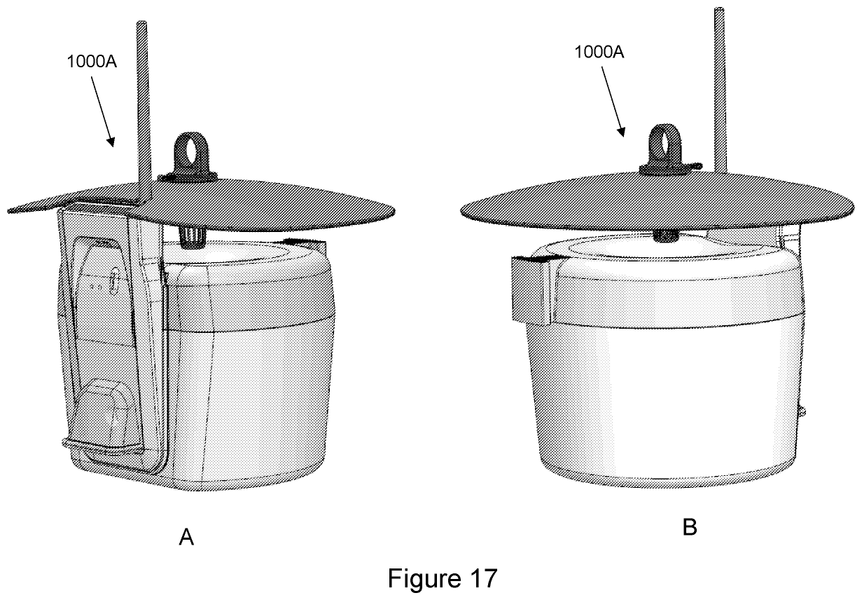

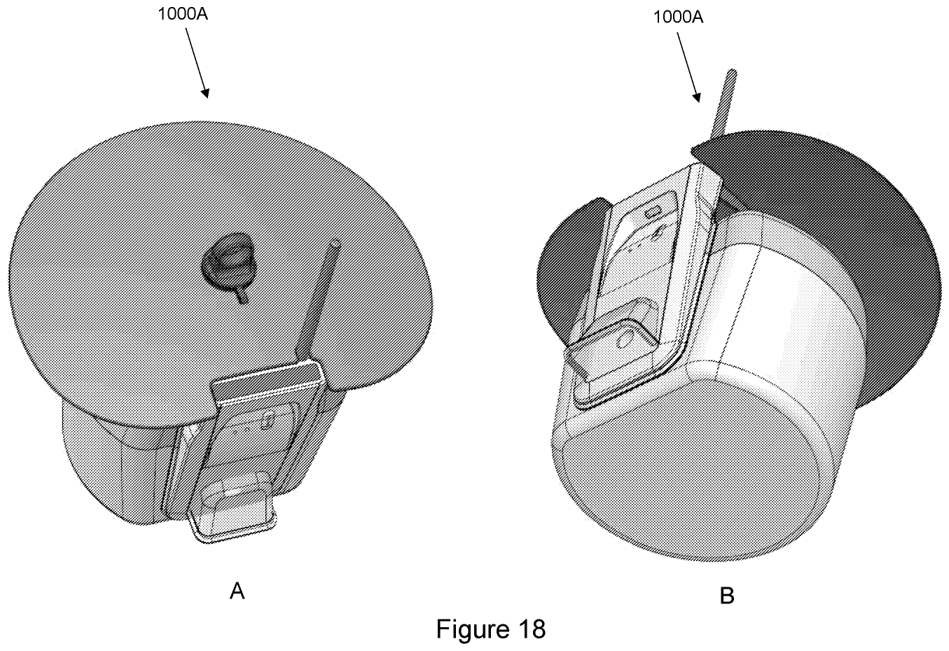

FIGS. 1 to 19 illustrate an embodiment of a device for monitoring and controlling insect pests, device 1000A. Device 1000A is adapted for monitoring and controlling relatively large moths. Device 1000A is particularly adapted for monitoring and controlling moth pests in the family Noctuidae, such as fall armyworm (FAW) by way of non-limiting example.

Device 1000A comprises a sensor component in the form of sensor device 100A; and a first receptacle component in the form of receptacle device 200A. Device 1000A further comprises: second receptacle 300A; lid 400A; attractant holder 500A; and mount 600A.

Broadly, receptacle device 200A is connectable to a post or picket via mount 600A; sensor device 100A is connectable to receptacle device 200A; second receptacle 300A and lid 400A are connectable to sensor device 100A; and attractant holder 500A is connectable to lid 400A.

To avoid doubt, device 1000A may be considered a modular device. Alternatively, device 1000A may be considered a system comprising sensor device 100A; and receptacle device 200A. In either case, second receptacle 300A, lid 400A, attractant holder 500A, and mount 600A may be considered optional attachments of device or system 1000A.

Second receptacle 300A may (without limitation) be considered part of or an optional attachment for sensor device 100A.

Lid 400A, attractant holder 500A, and mount 600A may (without limitation) be considered part of or optional attachments for receptacle device 200A.

Sensor device 100A is an electronic device comprising housing 110A; insect sensor 120A; environmental sensor aperture 130A; power source 140A; wireless data transmitter 150A; processor 160A; user interface button 170A; and indicator lights 180A.

Housing 110A of sensor device 100 has a general shape of an elongated wedge or triangular prism, comprising broader first or top end 111A; narrower second or bottom end 112A; rectangular first or front face 113A; and rectangular second or back face 114A. Rims 1141A extend from back face 114A of housing 110A. Groove 1121A is formed in bottom end 112A of housing 110A.

Housing 110A further comprises cylindrical channel 115A extending therethrough. Cylindrical channel 115A extends from housing entry aperture 1151A of back face 114A of housing 110A to housing exit aperture 1152A of front face 113A of housing 110A, at a central position towards bottom end 112A. As depicted, cylindrical channel 115A has a diameter of approximately 15 mm.

Housing 110A further comprises channel entry guide 116A; and channel exit guide 117A. Channel entry guide 116A and channel exit guide 117A are transparent or translucent, beak- or awning-like components.

Channel entry guide 116A extends from back face 114A of housing 110A over channel 115A. Channel entry guide 116A narrows from open lower portion 1161A below channel 115A to upper connection portion 1162A above channel 115A.

Channel exit guide 117A extends from front face 113A of housing 110A over channel 115A. Channel exit guide 117A narrows from open lower portion 1171A below channel 115A to upper connection portion 1172A above channel 115A.

Sensor 120A of sensor device 100A is a ring-shaped sensor extending around channel 115A at back face 114A of housing 110A. Sensor 120A comprises substantially flat sensing surface 121A.

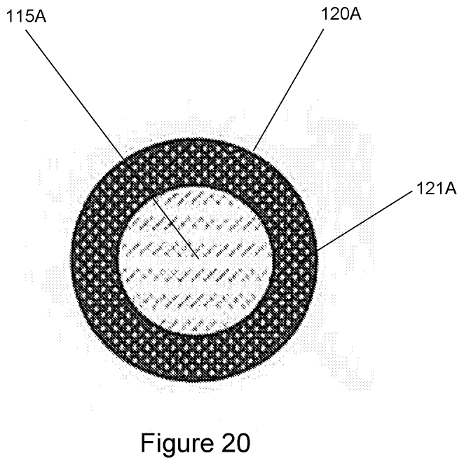

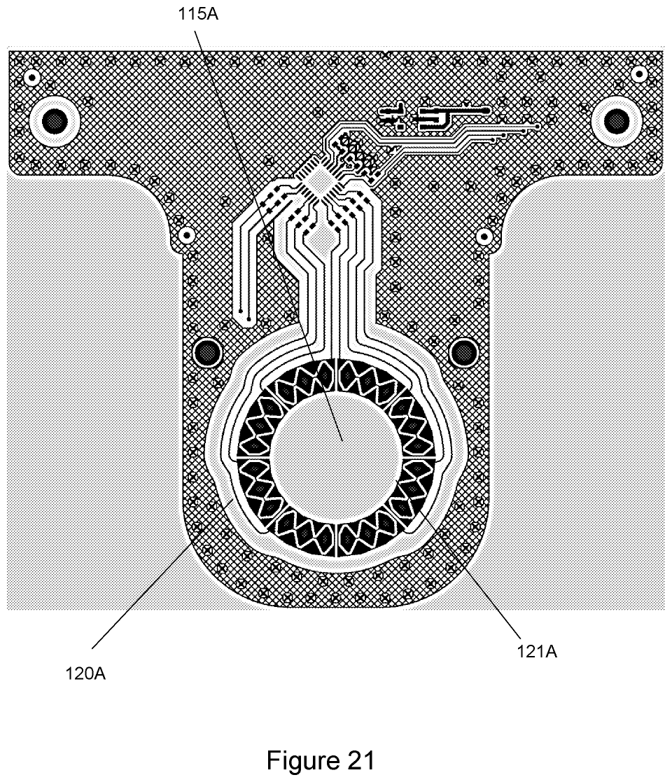

Sensor 120A of sensor device 100A is schematically depicted in FIG. 20. Typically, sensor 120A is an electrode capacitance sensor as described in detail in International Publication Number WO2018/068092, incorporated herein in full by reference. Typically, sensor 120A is a printed circuit board (PCB) sensor, as exemplified in FIG. 21.

Environmental sensor opening 130A of sensor device 100 comprises temperature sensor 131A; and humidity sensor 132A, internally located within housing 110A. Environmental sensor opening 130A is under overhang 1111A extending from top end 111A of housing 110A. Typically, temperature sensor 131A and humidity 132A are of the PCB comprising sensor 120A.

Power source 140A of sensor device 100A comprises rechargeable lithium-ion battery 141A; and photovoltaic cell 142A. Rechargeable lithium-ion battery 141A is located within housing 110A. Photovoltaic cell 142A is attached to top end 111A of housing 110A.

Wireless data transmitter 150A of sensor device 100A comprises mobile broadband component 151A; and antenna 152A. Mobile broadband component 151A, such as a narrowband Internet of Things (IoT), Category M1 (CATM1), 4G or 5G modem, or other suitable wireless component, is located within housing 110A. Antenna 152A extends from top end 111A of housing 110A.

Processor 160A of sensor device 100A, typically a microprocessor or microcontroller, is located within housing 110A. Processor 160A comprises or is associated with random-access memory (not shown).

User interface button 170A is an actuatable button located within a depression of housing 110A below overhang 1111A.

Indicator lights 180A comprise first and second indicator lights, located near to user interface button 170A.

Sensor device 100A may further comprise a data storage component (not shown) comprising non-volatile memory, such as a solid-state drive and/or an SD card slot or similar.

Receptacle device 200A of device 1000A comprises receptacle body 210A, which is a substantially hollow body comprising receptacle body top 211A; receptacle body bottom 212A; and receptacle body side wall 213A extending between top 211A and bottom 212A.

Receptacle body top 211A is removably attachable to receptacle body side wall 213A in a lid-type arrangement. Receptacle body top 211A comprises centrally located funnel-like insect entry portion 2111A, leading into the hollow receptacle body. Receptacle body top further comprises lug 2112A for connection with mount 600A.

As depicted, receptacle bottom 212A of receptacle body 210A is a substantially sealed floor. In some embodiments, receptacle bottom 212A may comprise relatively small drainage holes (not shown).

Receptacle body side wall 213A comprises rounded front part 2131A; and substantially flat back part 2132A. Open insect exit portion 2133A of receptacle body 210A is formed in back part 2132A of side wall 213A and a corresponding back part of receptacle body top 211A. Grooves 2134A extend along side edges of insect exit portion 2133A. Rim 2135A extends from a lower edge of insect exit portion 2133A.

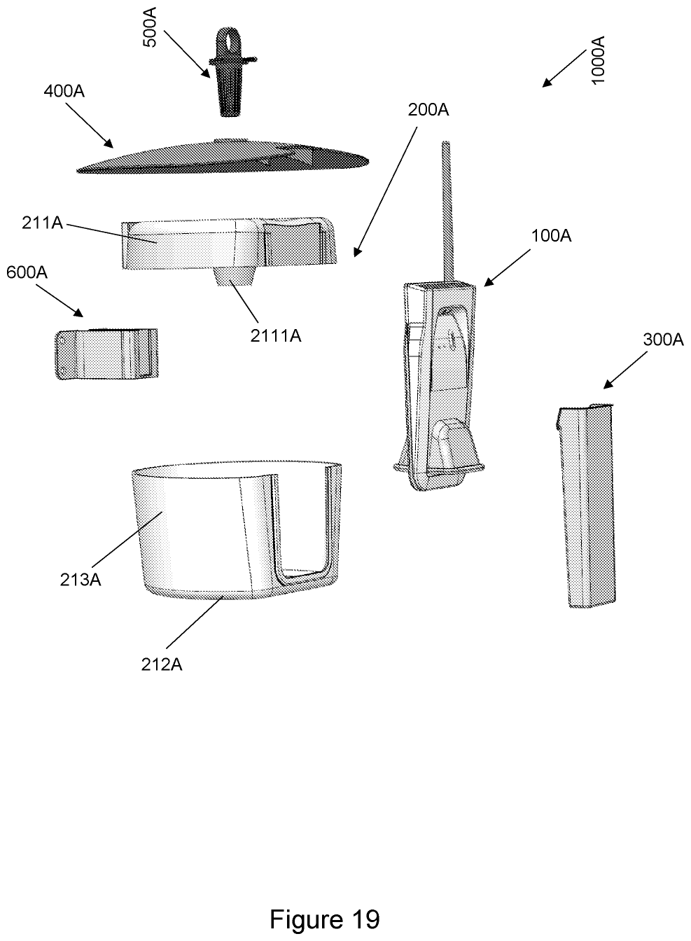

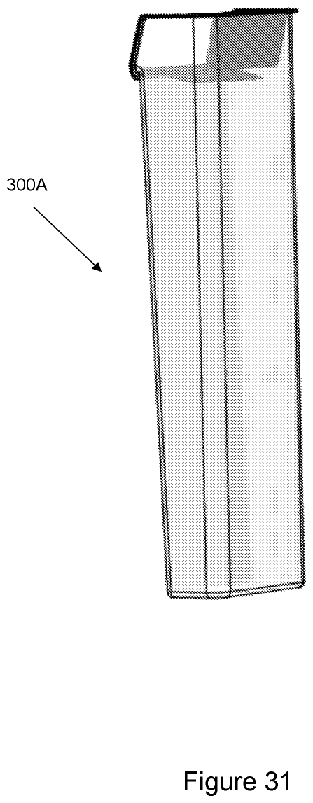

Second receptacle 300A is in the form of an elongated, substantially rectangular, substantially hollow body. Second receptacle 300A may be opaque, as depicted in FIG. 19. Alternatively, receptacle 300A may be translucent or transparent, as depicted in FIG. 31. Second receptacle narrows somewhat from top connection end 310A to bottom end 320A. Top connection end 310A of second receptacle 300A is adapted for connection with open lower portion 1171A of channel exit guide 117A of device 100A. Top connection end 310A comprises internal, sprung insect gate 311A.

Lid 400A is a substantially shield-like lid comprising lid aperture 410A; and lid connection portion 420A. Lid aperture 410A is located substantially centrally and extends through lid 400A. Lid connection portion 420A comprises lid notch 421A; and lid brace 422A.

Attractant holder 500A is a plug like component comprising ringed handle 510A; and substantially hollow, caged body 520A. Ringed handle 510A of attract holder 500A is releasably attachable to caged body 520A. Attractant holder release tab 530A facilitates separation of ringer handle 510A from caged body 520A.

Picket mount 600A is a bracket-like mount comprising picket securing base 610A; and receptacle receiving slot 620A.

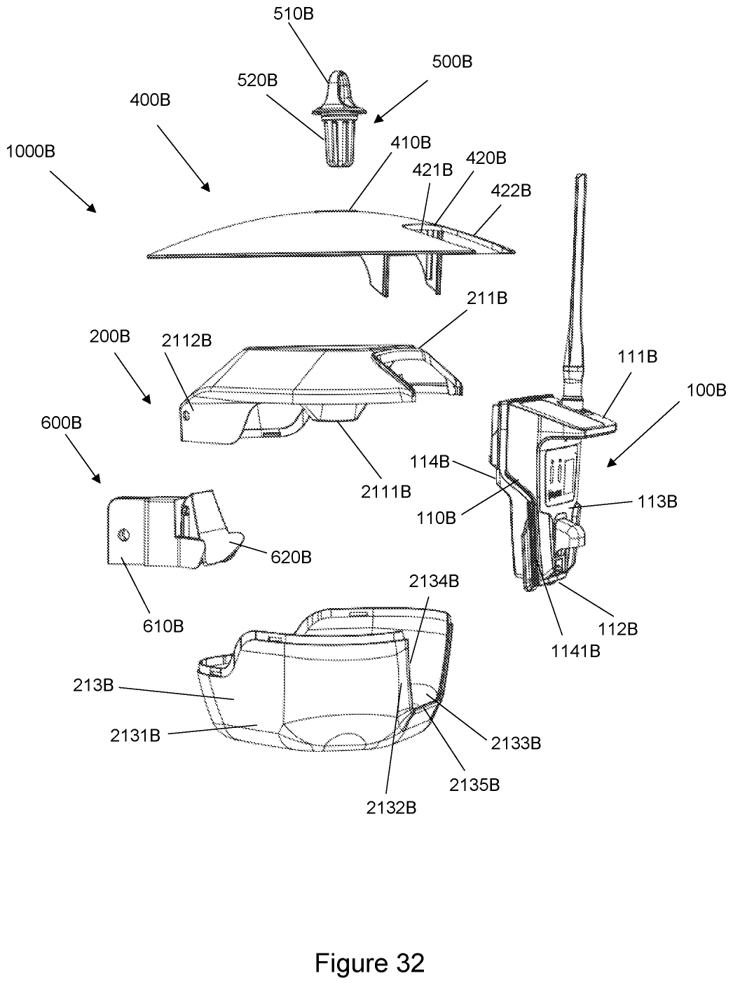

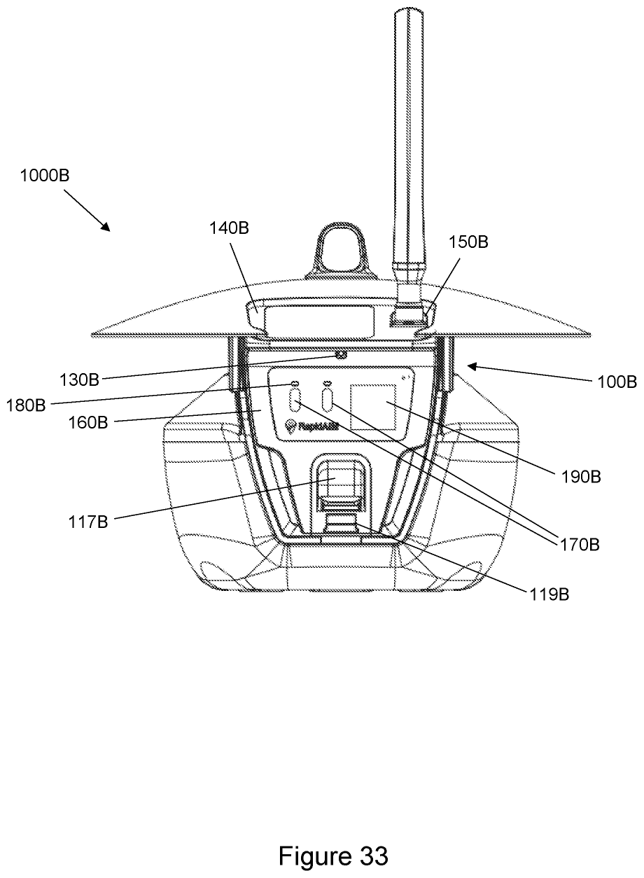

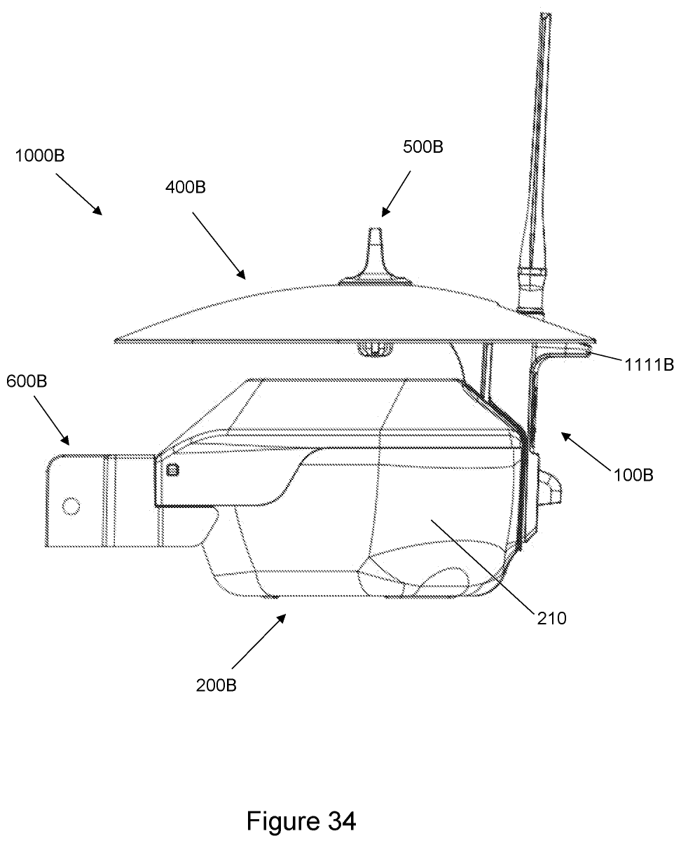

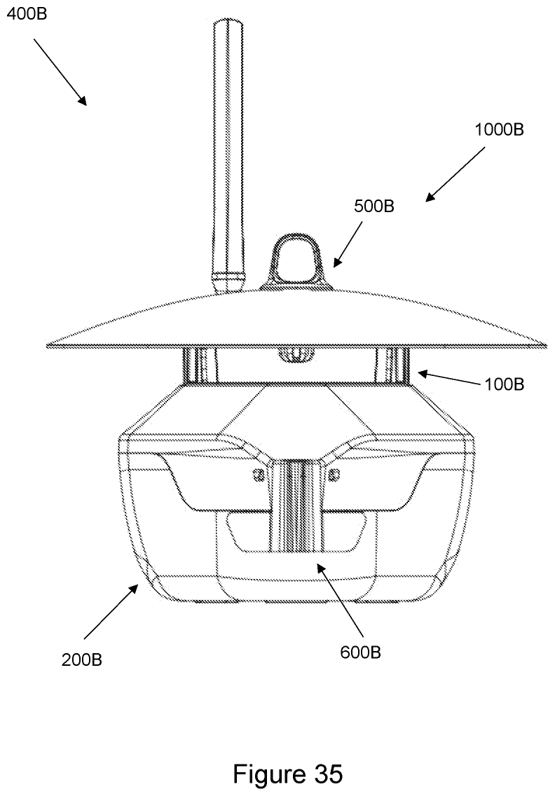

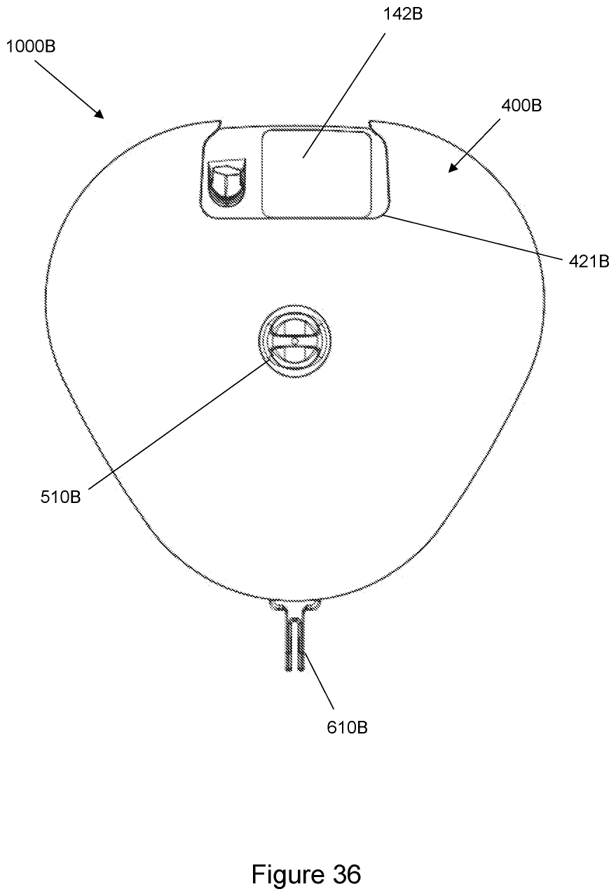

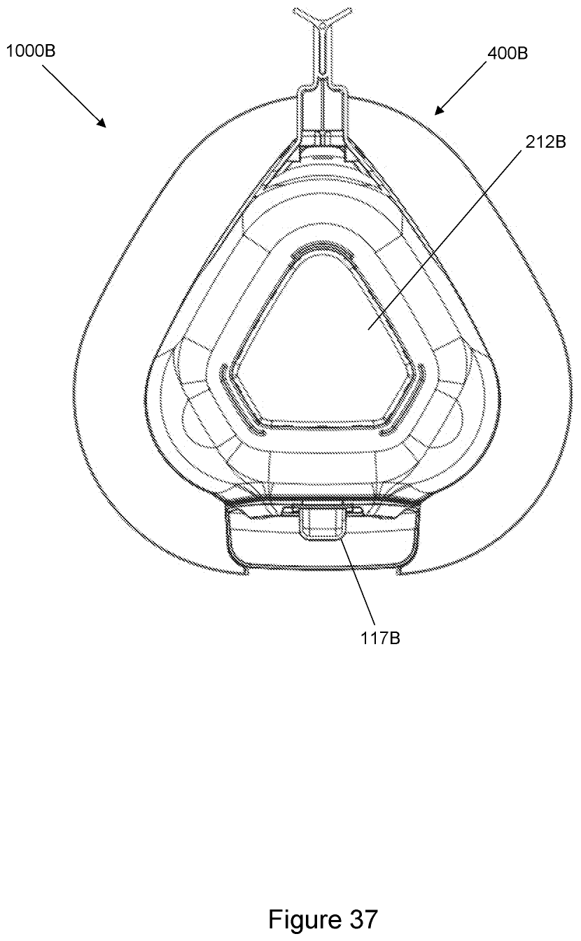

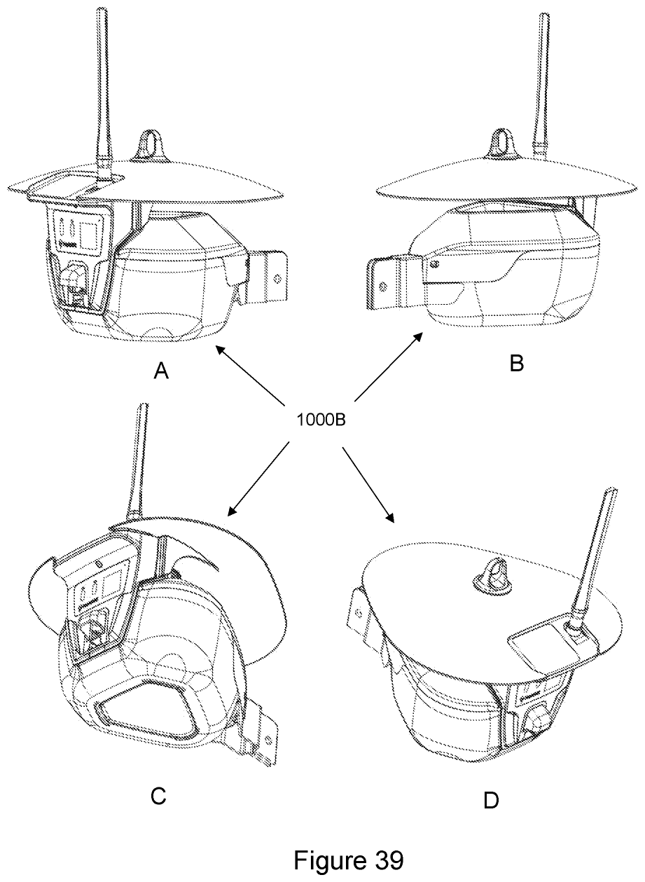

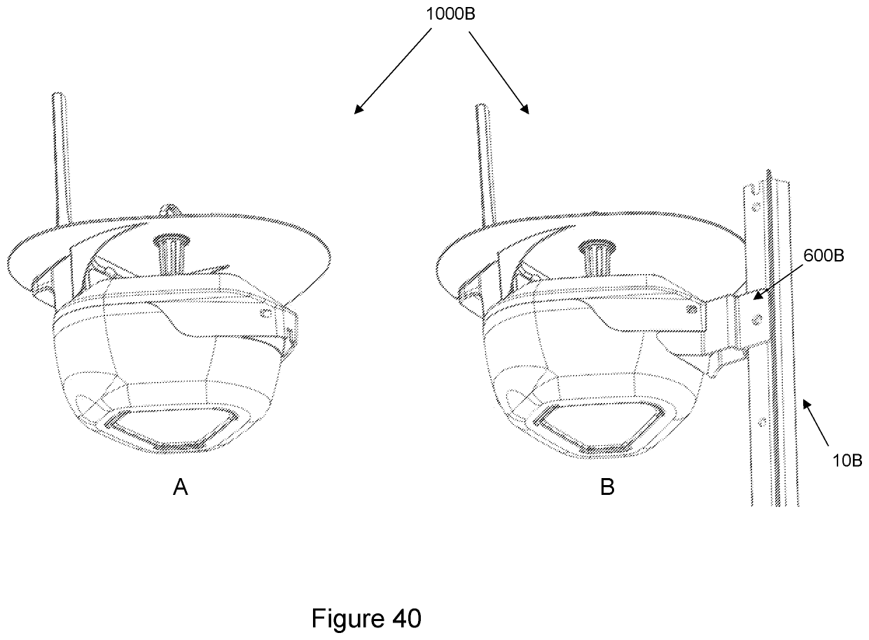

FIGS. 32 to 41 illustrate another embodiment of a device for monitoring and controlling insect pests, device 1000B. Device 1000B shares substantial similarity with device 1000A as will be evident from the following description. However, attention will be drawn to certain significant differences between device 1000A and 1000B hereinbelow.

Device 1000B comprises a sensor component in the form of sensor device 100B; and a first receptacle component in the form of receptacle device 200B. Device 1000B further comprises: lid 400B; attractant holder 500B; and mount 600B.

Broadly, receptacle device 200B is connectable to a post or picket via mount 600B; sensor device 100B is connectable to receptacle device 200B; lid 400B is connectable to sensor device 100B; and attractant holder 500B is connectable to lid 400B.

To avoid doubt, device 1000B may be considered a modular device. Alternatively, device 1000B may be considered a system comprising sensor device 100B; and receptacle device 200B. In either case, lid 400B, attractant holder 500B, and mount 600B may be considered optional attachments of device or system 1000B.

Lid 400B, attractant holder 500B, and mount 600B may (without limitation) be considered part of or optional attachments for receptacle device 200B.

Sensor device 100B shares broad similarity with sensor device 100A as will be evident from the following description. However, attention will be drawn to certain significant differences between sensor device 100A and sensor device 100B hereinbelow.

Sensor device 100B is an electronic device comprising housing 110B; insect sensor 120B; environmental sensor aperture 130B; power source 140B; wireless data transmitter 150B; processor 160B; user interface buttons 170B; and indicator lights 180B. Sensor device 100B also comprises device code 190B, linking to sensor device information.

Housing 110B comprises broader first or top end 111B; narrower second or bottom end 112B; first or front face 113B; and second or back face 114B. Housing 110B of sensor device 100B is comparatively less elongated than housing 110A of sensor device 100A. Housing 110B is substantially trapezoidally prismatic in overall shape.

In place of rims 1141A and groove 1121A of housing 110A of housing 110A, housing 110B comprises rim and seal arrangement 1141B extending around housing 110B.

As compared to cylindrical channel 115A of housing 110A comprising housing entry aperture 1151A and housing exit aperture 1152A, housing 110B comprises housing a different housing entry, exit, and channel arrangement.

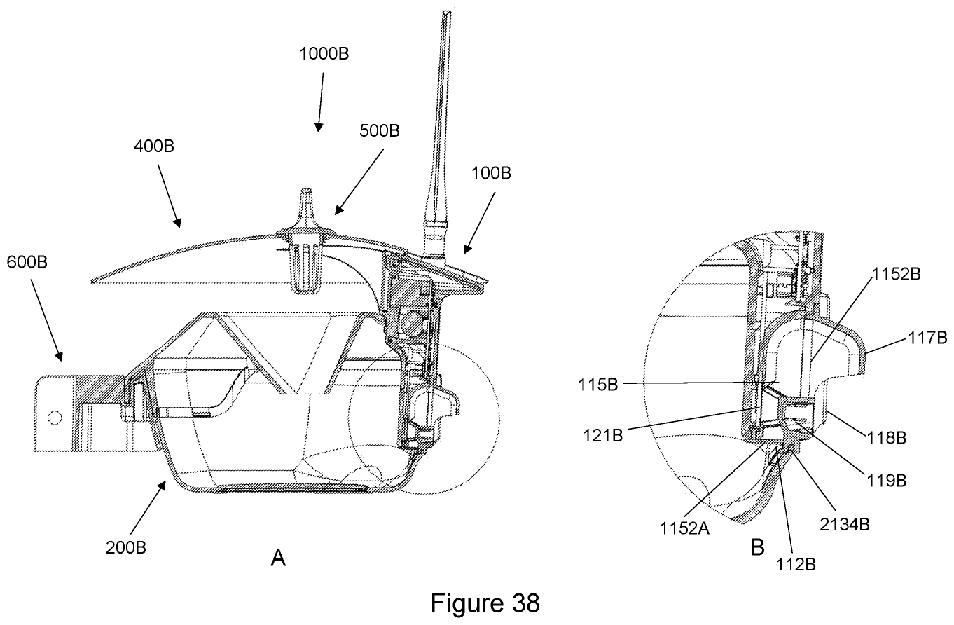

As clearly seen in FIG. 38, channel 115B of housing 110B extends from housing entry aperture 1151B of bottom end 112B of housing 110B to housing exit aperture 1152B of front face 113B of housing 110B. Housing exit aperture 1152B is a substantially square aperture. As compared to housing exit aperture 1152A, housing exit aperture 1152B is a substantially larger aperture.

Housing 110B further comprises channel exit guide 117B. Channel exit guide 117B is a transparent or translucent, beak- or awning-like component. Channel exit guide 117B extends from front face 113B of housing 110B over housing exit aperture 1152B.

A channel entry guide such as guide 116A of housing 110A is absent from housing 110B of device 100B.

Housing 110B further comprises restrictor 119B, which restrictor is absent from housing 110A. Restrictor 119B comprises a substantially polygonal protrusion comprising void 1191B extending inwards from front face 113B of housing 110B, below housing exit aperture 1152B.

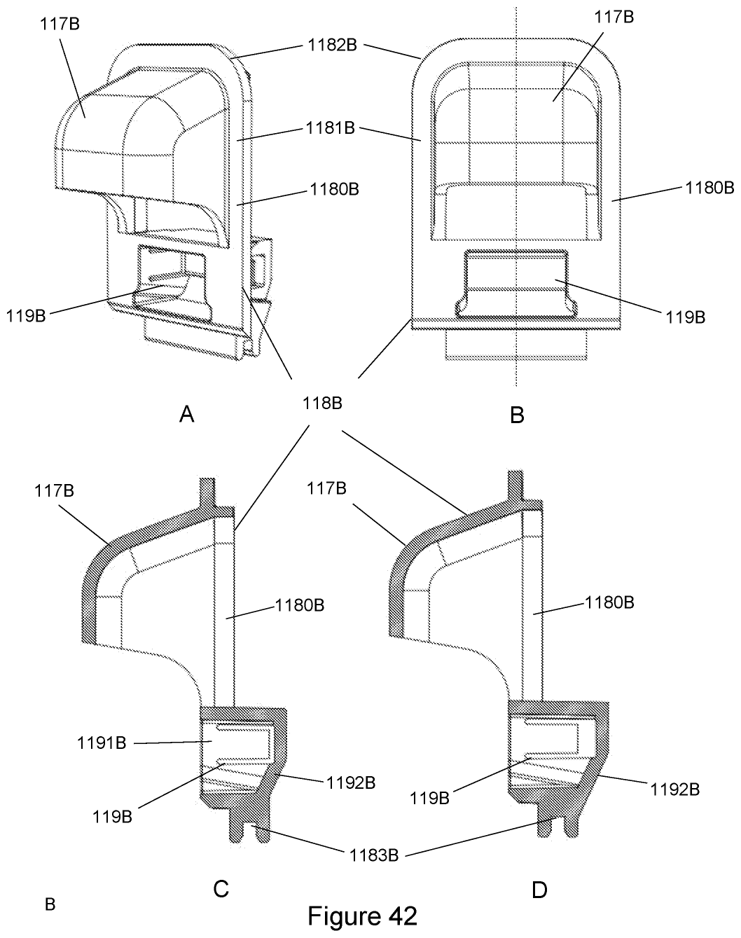

As clearly seen in FIG. 42, channel exit guide 117B and restrictor 119B are of exchangeable combined exit guide and restrictor component 118B of housing 110B, which component is absent from housing 110A.

Combined exit guide and restrictor component 118B comprises combined exit guide and restrictor body 1180B. Channel exit guide 117B is of a first or upper portion of body 1180B and projects laterally in a first direction. Restrictor 119B is of second or lower portion of body 1180B and extends laterally in a second direction opposite the first direction. Body 1180B further comprises face 1181B; rim 1182B; and connector slot 1183B.

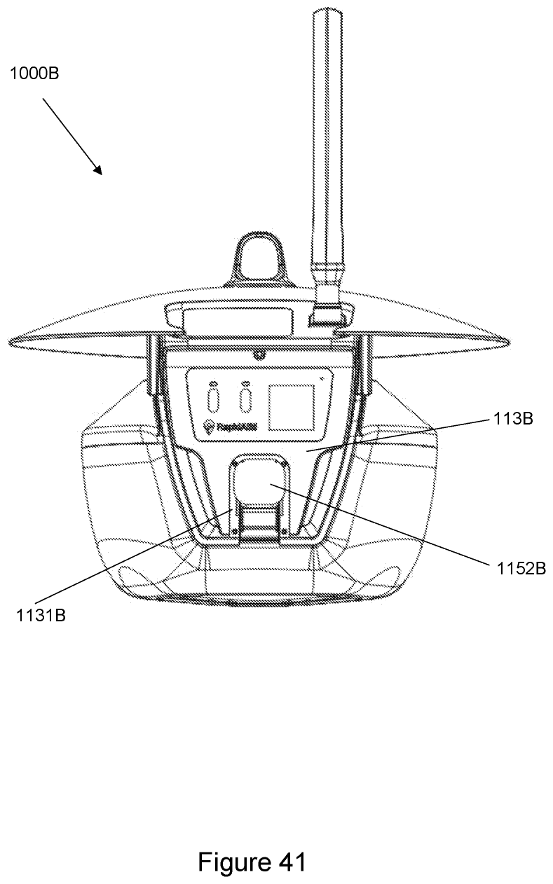

As clearly seen in FIG. 41, front face 113B of housing 110B comprises receiving portion 1131B for connection with exchangeable combined exit guide and restrictor component 118B. Receiving portion 1131B comprises notch 1132B with which restrictor 119B fittingly engages; and indentation 1133B with which rim 1182B fittingly engages, such that face 1181B of combined exit guide and restrictor component 118B sits substantially flush with front face 113B of housing 110B of sensor device 100B. To avoid doubt, at least when connected to housing 1101B, combined exit guide and restrictor component 118B may be considered part of housing 110B.

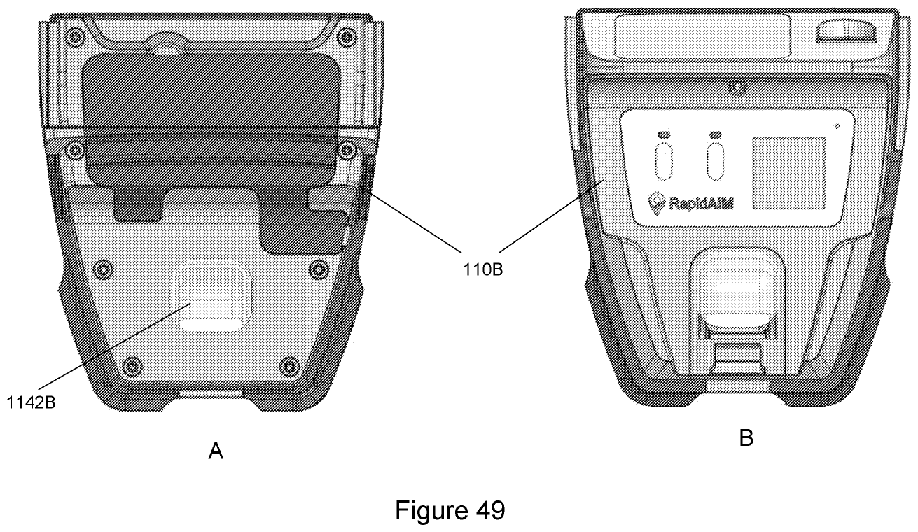

As clearly seen in FIG. 49, housing 110B further comprises window 1142B. Window 1142B is a translucent or substantially transparent window in back face 114B of housing 110B. Window 1142B is opposite housing exit aperture 1152B of front face 113B. When device 100B is connected to receptacle 200B, window 1142B allows ambient light from housing aperture 1152B through into receptacle 200B. To avoid doubt, window 1142B is solid and fittingly engaged with back 114B, and not for arthropod passage therethrough.

As compared to that of 120A of sensor device 100A, sensor device 100B comprises a different sensor arrangement, described below.

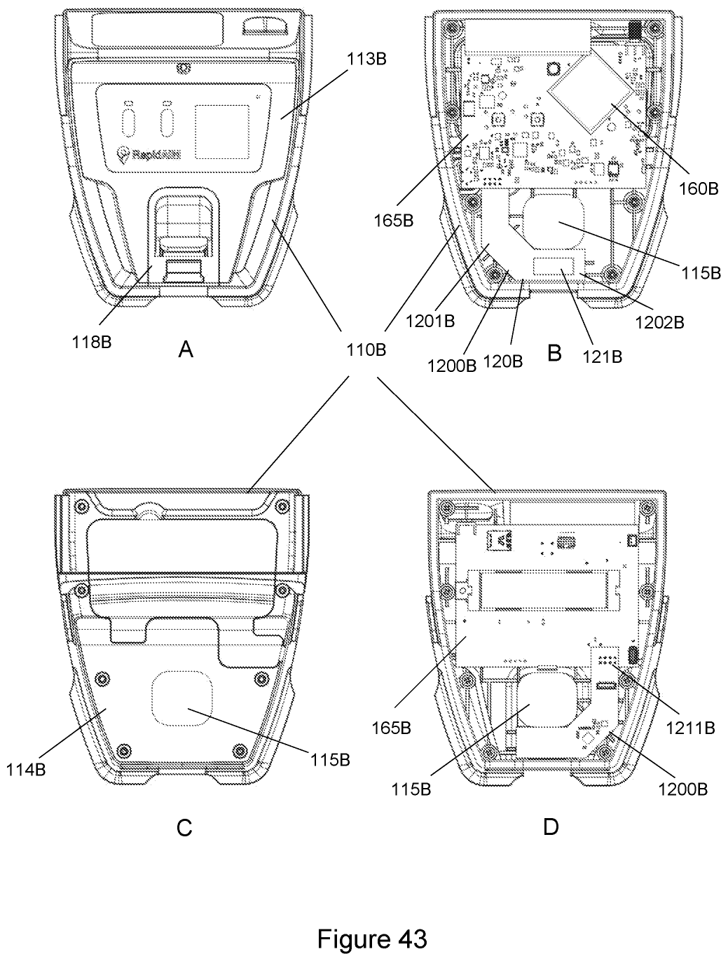

As shown in FIG. 43, sensor device 100B comprises substantially rectangular sensing surface 121B. As clearly seen in FIG. 38, sensing surface 121B of sensor device 100B is located towards bottom end 112B of housing 110B, facing away from back face 114B. When combined exit guide and restrictor component 118B is connected to housing 1101B, sensing surface 121B is located opposite restrictor 119B, within channel 115B.

As for sensor 120A, typically, sensor 120B is an electrode capacitance sensor as described in detail in International Publication Number WO2018/068092, incorporated herein in full by reference. Typically, sensor 120B is a printed circuit board (PCB) sensor.

Notably, sensor 120B is an exchangeable sensor. As described herein, both sensor 120A of sensor device 100A, and sensor 120B of sensor device 100B, are typically PCB sensors. An important difference between PCB sensor 120A of device 100A and PCB sensor 120B of device 100B is that sensor 120A is of a main or primary PCB, whereas sensor 120B is of a separate exchangeable sensor PCB.

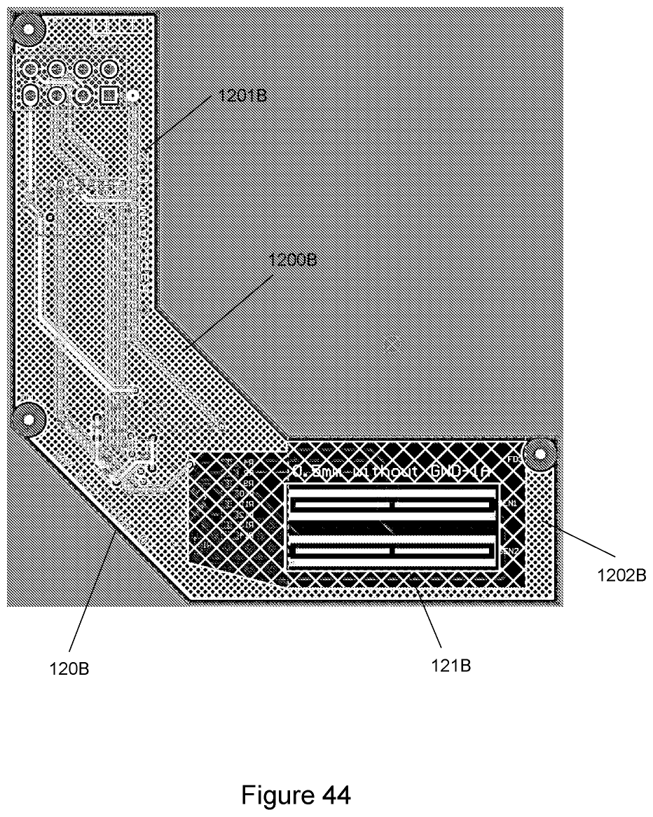

As clearly seen in FIG. 44B, exchangeable sensor 120B of device 100B comprises sensor body 1200B. Sensor body 1200B comprises sensor head 1202B and connector arm 1201B. Sensing surface 121B is located on sensor head 1202B. Connector arm 1201B comprises releasable connection point 1211B towards an end opposite sensor head 1202B. Connection site 1211B is for connection with primary PCB 165B of sensor device 100B. The overall shape of exchangeable sensor 120B

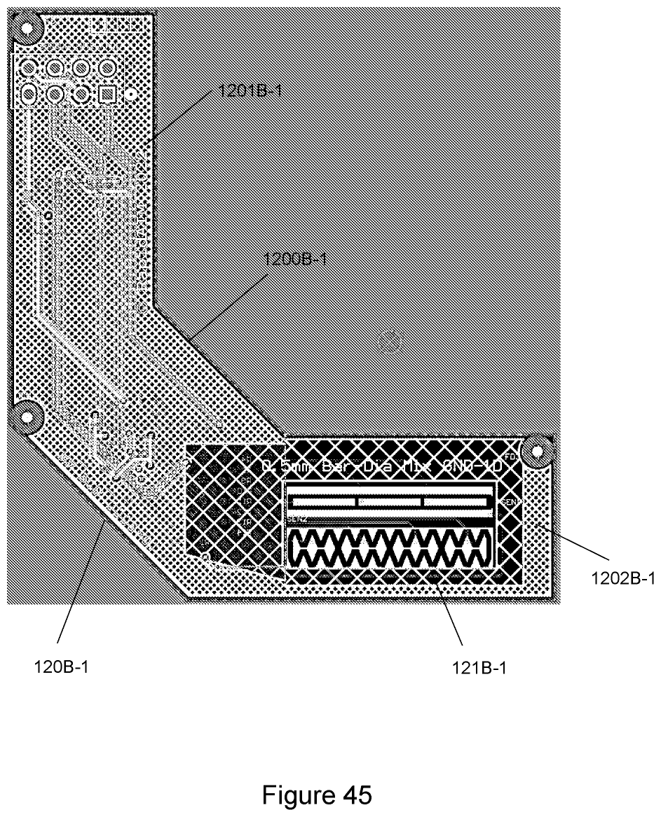

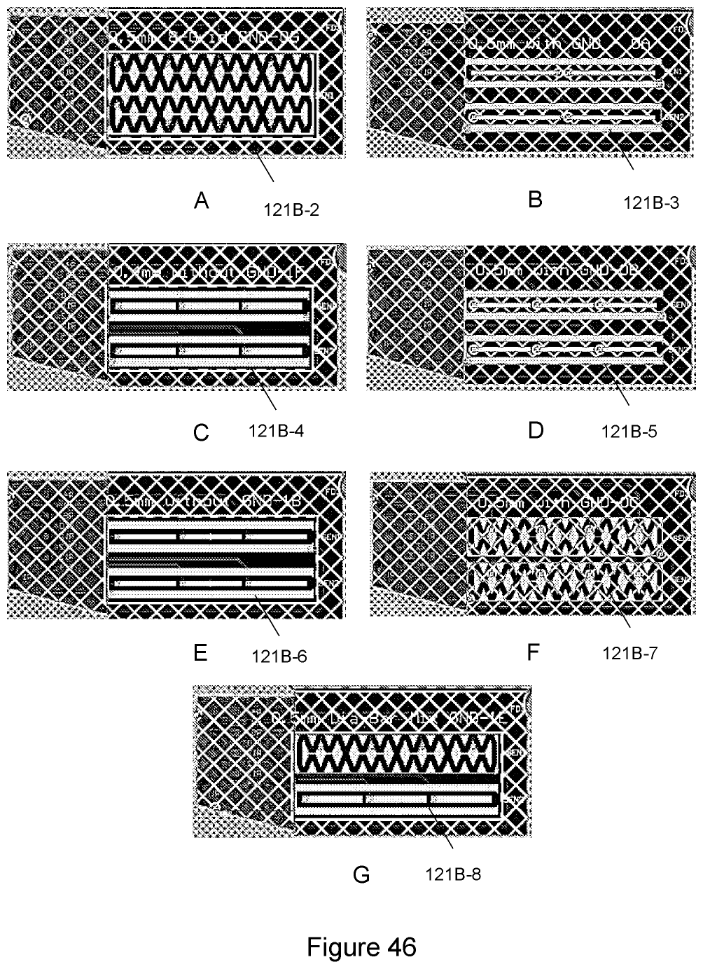

Further examples of exchangeable PCB sensor 120B and sensing surface 121B thereof are provided in FIG. 45 and FIG. 46, and are discussed hereinbelow.

Environmental sensor opening 130B of sensor device 100 comprises temperature sensor 131B; and humidity sensor 132B, internally located within housing 110B. Environmental sensor opening 130B is under overhang 1111B extending from top end 111B of housing 110B. Typically, temperature sensor 131B and humidity 132B are of primary PCB 165B.

Power source 140B of sensor device 100B comprises rechargeable lithium-ion battery 141B; and photovoltaic cell 142B. Rechargeable lithium-ion battery 141B is located within housing 110B. Photovoltaic cell 142B is attached to top end 111B of housing 110B.

Wireless data transmitter 150B of sensor device 100B comprises mobile broadband component 151B; and antenna 152B. Mobile broadband component 151B, such as a NBIOT, CATM1, 4G or 5G modem or other suitable wireless component, is located within housing 110B. Antenna 152B extends from top end 111B of housing 110B.

Processor 160B of sensor device 100A, typically a microprocessor or microcontroller, is located within housing 1101B, typically of or connected to primary PCB 165B. Processor 160B comprises or is associated with random-access memory (not shown).

User interface buttons 170B comprise first and second actuatable buttons located below overhang 1111B.

Indicator lights 180B comprise first and second indicator lights, located near to user interface buttons 170B.

Code 190B is digital barcode, typically a QR code, linking to information to assist with deployment of sensor device 1001B, such as deployment in the context of systems as hereinbelow described. Device 100A may comprise a similar code, code 190A (not shown).

Sensor device 100B may further comprise a data storage component (not shown) comprising non-volatile memory, such as a solid-state drive and/or an SD card slot or similar.

Receptacle device 200B of device 1000B comprises receptacle body 210B, which is a substantially hollow body comprising receptacle body top 211B; receptacle body bottom 212B; and receptacle body side wall 213B extending between top 211B and bottom 212B.

Receptacle body top 211B is removably attachable to receptacle body side wall 213B in a lid-type arrangement. Receptacle body top 211B comprises centrally located funnel-like insect entry portion 2111B, leading into the hollow receptacle body. Receptacle body top further comprises rim 2112B for connection with mount 600B.

As depicted, receptacle bottom 212B of receptacle body 210B is a substantially sealed floor. In some embodiments, receptacle bottom 212B may comprise relatively small drainage holes (not shown).

Receptacle body side wall 213B comprises rounded front part 2131B; and substantially flat back part 2132B. Open insect exit portion 2133B of receptacle body 210B is formed in back part 2132B of side wall 213B and a corresponding back part of receptacle body top 211B. Grooves 2134B extend along side edges of insect exit portion 2133B.

Bottom 212B and side wall 213B of receptacle device 200B are shaped to form ramp portion 2136B, ramping upwards towards open insect exit portion 2133B. Receptacle device 200A does not comprise a corresponding ramp portion.

Device 1000B may comprise optional second receptacle 300B (not shown), broadly corresponding to second receptable 300A of device 1000A. Receptacle 300B may be in the form of a rigid or semi-rigid container, or a bag or the like. Receptacle 300B suitably comprises a connection portion adapted to engage with channel exit guide 117B. The connection portion may also engage with restrictor 119B or void 1191B thereof.

Lid 400B is a substantially shield-like lid comprising lid aperture 410B; and lid connection portion 420B. Lid aperture 410B is located substantially centrally and extends through lid 400B. Lid connection portion 420B comprises lid notch 421B; and lid brace 422B.

Attractant holder 500B is a plug-like component comprising ringed handle 510B; and substantially hollow, caged body 520B. Ringed handle 510B of attractant holder 500B is releasably attachable to caged body 520B.

Picket mount 600B is a bracket-like mount comprising picket securing base 610B; and receptacle receiving catches 620B.

Prior to use, device 1000A/1000B is assembled by connection of applicable components.

Receptacle body top 211A/211B is placed onto receptacle body side wall 213A/213B, wherein open insect exit portion is formed by attachment of back part 2132A/2123B of side wall 213A/213B with the corresponding back part of receptacle body top 211A/211B.

Sensor device 100A/100B is attached to receptacle device 200A/200B by inserting sensor device housing 110A/110B into receptacle body 210A/210B of receptacle device 200A/200B. In the case of device 1000A, rims 1141A of back face 114A of sensor device housing 110A are slid along grooves 2134A of insect exit portion 2133A of receptacle body 210A, until rim 2135A of receptacle body 210A enters groove 1121A of bottom end of housing 110A. In the case of device 1000B, rim and seal arrangement 1141B is sealingly engaged with 2134B of insect exit portion 2133B of receptacle body 210B.

Typically, lid 400A/400B is incorporated into device 1000A/1000B, by attachment of lid connection portion 420A/420B to sensor device 110A/110B. More particularly, lid notch 421A/421B is placed is placed over top end 111A/111B of housing 110A/110B and lid brace 422A/422B is supported against back face 114A/114B of housing 110A/110B.

Typically, attractant holder 500A/500B is incorporated into device 1000A/1000B, by attachment of attractant holder 500A/500B to lid 400A/400B. More particularly, caged body 520A/520B of attractant holder 500A/500B is inserted into lid aperture 410A/410B.

Typically (although without limitation), device 1000A/1000B is used for monitoring relatively large moths, such as moths in the family Noctuidae and of the genera Spodoptera, Heliothis, and Helicoverpa although without limitation thereto. With this in mind, typical use of device 1000A/1000B will be described as follows with reference to moths by way of example.

In use, a moth attractant, typically a species-specific pheromone or feeding stimulant, is placed within attractant holder 500A/500B. Caged body 520A/520B of the attractant holder is adapted to contain solid particles impregnated with moth attractant, while allowing some dispersal of the attractant itself away from attractant holder 500A/500B.

In use, the positioning of caged body 520A/520B centrally under lid 400A/400B and above funnel-like insect entry portion 2111A/2111B of receptacle body 210A/210B attracts moths into space between lid 400A/400B and receptacle body top 211A/211B from all directions towards insect entry portion 2111A/2111B.

When a moth contacts insect entry portion 2111A/2111B, the funnel-like structure causes the moth to fall through insect entry portion 2111A/2111B into the hollow interior of receptacle body 210A/210B.

When inside the hollow interior of receptacle body 210A/210B, the moth attempts to escape. In attempting to escape, the moth is drawn to sensor device 100A/100B in insect exit portion 2133A/2133B of receptacle body 210A/210B.

In the case of device 1000A, when attempting to escape, the moth is drawn to channel 115A extending through housing 110A of sensor device 100A inserted into insect exit portion 2133A. Translucent channel entry guide 116A extending from back face 114A of sensor device housing 110A allows the moth to visually identify channel 115A therethrough. Channel entry guide 116A allows the moth to move towards channel 115A only through open lower portion 1161A thereof.

When the moth moves towards channel 115A via open lower portion 1161A of channel entry guide 116A, the moth is brought into contact with sensing surface 121A of sensor 120A of sensor device 100A. As the moth enters channel 115A, the moth engages in a characteristic behaviour of abdomen dragging, sliding, gliding, and/or hovering across sensing surface 121A.

As the moth passes through channel 115A and exits receptacle body 210A via housing exit portion 1152A of housing 110A of sensor device 100A, channel exit guide 117A directs the moth towards and out of lower portion 1171A thereof.

In the case of device 1000B, when attempting to escape, the moth is drawn to channel window 1142B of sensor device 100B inserted into insect exit portion 2133B. With reference to FIG. 49, it will be appreciated that channel window 1142B presents as a relatively bright light source in an otherwise substantially dark receptacle body 210B.

The moth moves towards channel window 1142B along bottom 212B and up ramp portion 2136B of receptacle body 210B, entering housing entry aperture 1151B of bottom end 112B of housing 110B of sensor device 100B. As the moth moves through channel 115B towards housing exit aperture 1152B, the moth is restricted by restrictor 119B in passing sensing surface 121B of sensor 120B. As the moth passes sensing surface 121B restricted by restrictor 119B, the moth engages in characteristic behaviour of abdomen, dragging, sliding, gliding, and/or hovering past across sensing surface 121B.

As the moth passes through channel 115B and exits receptacle body 210A via housing exit portion 1152B of housing 110B of sensor device 100B, channel exit guide 117B directs the moth towards and out of lower portion 1171B thereof.

In use, when second receptacle 300A is attached to lower portion 1171A of exit guide 117A of sensor device 100A of device 1000A, the moth is directed past angled insect gate 311A of top connection end 310A of second receptacle 300A. Angled insect gate 311A substantially prevents the moth from exiting second receptacle 300A. Similar occurs when second receptacle 300B (not shown) is used in conjunction with device 1000B.

In use, environmental sensors 130A/130B of sensor device 100A/100B sense environmental conditions at the location of device 1000A/1000B. Temperature sensor 131A/131B senses ambient temperature at the location of device 1000A/1000B. Humidity sensor 132A/132B senses ambient humidity at the location of device 1000A/1000B.

In use, power source 140A/140B provides power for sensor device 100A/100B, including insect sensor 120A/120B, environmental sensors 130A/130B, wireless data transmitted 150A/150B, and processor 160A/160B thereof. More particularly, lithium-ion battery 141A/141B stores electrical energy and powers electrical components including components 120A/120B-160A/160B. Photovoltaic cell 142A/142B converts sunlight into electrical energy and can charge lithium-ion battery 141A/141B.

In use, wireless data transmitter 150A/150B can transmit data from sensor device 100A/100B and can receive data to sensor device 100A/100B. Typically, device 100A/100B is used in conjunction with a software application running on a computing device, typically a mobile computing device such as a smartphone, tablet, or laptop. In use, wireless data transmitter 150A/150B can exchange data between sensor device 100A/100B and the computing device, such as processed or unprocessed data obtained from insect sensor 120A/120B or environmental sensors 130A/130B. Typically, device 100A/100B is used in conjunction with a server, such as a cloud-based server. In use, wireless data transmitter 150A/150B can exchange data between sensor device 100A/100B and the server, either directly or via the computing device such as the smartphone, tablet, or laptop.

In use, processor 160A/160B processes data obtained by insect sensor 120A/120B and environmental sensors 130A/130B of sensor device 100A/100B. Typically, processor 160A/160B processes data prior to data being transmitted using wireless data transmitter 150A/150B, such as data transmitted to a mobile computing device. Processor 160A/160B may process data received by transmitter 150A/150B, such as data received from a mobile computing device.

In use, user interface button(s) 170A/170B can be actuated by a user to power sensor device 100A/100B on or off, and/or to convert sensor device 100A/100B between one or more modes such as an operational mode, a standby mode, and/or a maintenance mode or the like.

In use, indicator lights 180A/180B can be used to display a power on/off status and/or mode of operation of sensor device 100A/100B.

In use, code 190A/190B can link to information for sensor device 100A/100B to assist with deployment of the device or systems comprising the device.

It will be understood that device 1000/1000B is optimised for detection of certain large moths, as hereinabove described, based on behaviour of such moths when exiting a receptacle.

Device 1000A is optimised to encourage and detect abdomen dragging, sliding, gliding, and/or hovering behaviour of certain large moths when passing a sensor into a cylindrical channel of restricted diameter in order to exit a receptacle.

Similarly, device 1000B is optimised to encourage and detect abdomen dragging, sliding, gliding, and/or hovering behaviour of certain large moths when passing a sensor via a restricted portion of a channel in order to exit a receptacle.

Optionally, device 1000A/1000B may be used for controlling insects, such as moths. When used for controlling insects, second receptacle 300A/300B is typically not included in device 1000A/1000B, such that exit guide 117A/117B is open to the surrounding environment.

For control of insects using device 1000A/1000B, a suitable control agent such as a slow-acting insecticide or, more typically, a biocontrol agent such as a moth-infecting fungal, bacterial, viral pathogen, or diatomaceous earth is placed within the hollow interior of receptacle body 210A/210B.

When a moth enters the hollow interior of receptacle body 210A/210B containing the slow-acting control agent, the slow-acting control agent contacts the moth. The slow-action control agent does not immediately harm or kill the moth, such that the moth exits receptacle body 210A/210B via housing exit portion 1152A/1152B of housing 110A/110B of sensor device 100A/100B as hereinabove described.

With exit guide 117A/117B open to the surrounding environment, the moth contacted by the slow-acting control agent can enter the environment. Where the slow-acting control agent is a biocontrol agent, the moth contacted by the biocontrol agent can spread infection within a moth population, facilitating more general control of the moth population.

Certain advantages of at least some aspects and/or embodiments of the invention as described herein will now be described.

Devices 1000A/1000B facilitate detection and monitoring of insects, in particular large moths, while enabling return of the detected insects into the environment. This arrangement can be particularly advantageous as accumulation of insects within receptacle device 200A/200B is avoided or at least substantially minimised.

As hereinabove described, avoidance of accumulation of insects within devices such as device 1000A/1000B can have important advantages with respect to efficiency and scalability. It will be appreciated that in insect trap arrangements dead and dying insects accumulate, necessitating emptying of traps at regular intervals. Additionally, in at least some cases, insect trap arrangements may include trap components that require regular replacement, e.g. sticky insect cards.

By allowing for insect monitoring without substantial accumulation of insects, device 1000A/1000B can operate for extended periods without the need for maintenance such as trap emptying or trap component replacement. Furthermore, this property of device 1000A/1000B can allow for increased scalability. It will be appreciated that, logistically, decreased requirements for visitation of individual trap sites for maintenance can allow for an increased number of traps to be used in conjunction, facilitating monitoring over a larger spatial area.

Advantageously, device 1000A/1000B facilitates efficient sensing of movement patterns of insects on exit from a receptacle. Movement of at least certain insects, such as relatively large moths, when exiting a receptacle can be highly advantageous for accurate identification of the insects.

As set out herein, device 1000A/1000B is a component device, comprising sensor device 100A/100B and receptacle device 200A/200B. Devices comprising removably attachable or modular components, such as device 1000A/1000B, can be highly advantageous in the context of the present invention.

It will be appreciated that sensor device 100A/100B comprises comparatively complex and expensive electronic components, whereas device 200A/200B comprises comparatively simple and cheap predominantly structural components. Advantageously, receptacle device 200A/200B can be replaced while the same sensor device 100A/100B is retained. As hereinbelow described, receptacle device 200A/200B (or components thereof) may be recyclable or compostable etc.

Furthermore, the modular relationship of receptacle device 200A/200B and sensor device 100A/100B can allow for use of various embodiments of receptacle device with sensor device 100A/100B. Advantageously, this can allow modifications of receptacle device to facilitate optimised detection of different insects using the same sensor device 100A/100B.

Advantageously, device 1000A/1000B can facilitate control of insects by inclusion of a control agent within the hollow body of receptacle 200A/200B.

Advantageously, device 1000A/1000B can be arranged to allow insects treated with control agent to pass into the environment surrounding device 100A/100B. This can be particularly advantageous when a biocontrol agent is used with device 1000A/1000B, as an insect infected with the biocontrol agent by contact using device 1000A/1000B can spread infection within a population of the insect, facilitating more general biocontrol.

As hereinabove described, the ability of device 1000A/1000B to monitor for insects while avoiding substantial trapping and accumulation of insects therein has important advantages. However, in some instances it may be useful to trap insects in the context of the present invention, such as for quality control assurance purposes, e.g. to confirm the identity of insects detected using device 1000A/1000B. Advantageously, second receptacle 300A/300B allows for trapping of insects detected using device 1000A/1000B, where this is desirable. Advantageously, the removable nature of second receptacle 300A/300B allows for device 1000A/1000B to function as an insect trap on a temporary or intermittent basis, e.g. for quality assurance purposes.

Advantageously, sensor device 100A/100B is a fully integrated device facilitating solar power collection, insect sensing, and transmission and receipt of data using broadband internet.

Advantageously, device 1000A/1000B can be used in conjunction with computing equipment and software for effective and substantially real-time monitoring of insect pests, and can be used in this context to obtain estimates of pest population characteristics. Typically, device 1000A/1000B is used in conjunction with a mobile computing device such as a smartphone, laptop, or tablet, the mobile computing device running a suitable software application. Typically, device 1000A/1000B is used in conjunction with a server, such as a cloud-based server, receiving and/or sending data from the server directly and/or via the mobile computing device.

Advantageously, multiple devices 1000A/1000B can form a parallel or linked system arrangement with suitable computing equipment and software, which can facilitate high resolution and accurate detection and/or estimation of insect pest characteristics. Multiple devices 1000A/1000B can be arranged in schematics, such as grid patterns, which can facilitate increased accuracy of detection and/or estimation of pest characteristics. As hereinabove described, due to reduced need for maintenance and/or trap emptying, device 1000A/1000B can make use of comparatively large numbers of devices logistically feasible providing increased scalability.

In some typical embodiments, between about 5 and about 500 devices 1000 are used in a parallel or linked fashion with suitable computing equipment, including about 10, 20, 30, 40, 50, 60, 70, 80, 90, 100, 150, 200, 250, 300, 350, 400, and 450 devices 1000. More typically between about 20 and 200 devices 1000 are used in a parallel or linked fashion with suitable computing equipment, including about 30, 40, 50, 60, 70, 80, 90, 100, 110, 120, 130, 140, 150, 160, 170, 180, and 190 devices 1000A/1000B.

In some typical embodiments, multiple devices 1000A/1000B are arranged at a spatial density of between one device per about 0.1 km² to one device per about 10 km², including one device per about: 0.2, 0.3, 0.4, 0.5, 0.6, 0.7, 0.8, 0.9, 1, 2, 3, 4, 5, 6, 7, 8, and 9 km². It will be understood that multiple devices 1000A/1000B may be arranged over tens, hundreds, or thousands of square kilometres.

Advantageously, sensor device 100A/100B comprises environmental sensors for sensing environmental conditions at a location of device 1000A/1000B. Monitoring of environmental characteristics by sensing with environmental sensors may provide advantageous information for the purposes of insect pest epidemiology etc., in the context of the present invention.

In at least some circumstances, features of device 10001B, and particularly sensor device 100B thereof, may be particularly advantageous.

As hereinabove described, the arrangement of sensing surface 121B and channel 115B of sensor device 100B differs from that of sensing surface 121A and channel 115A of sensor device 100B.

Notably, the arrangement of sensor device 100B, wherein the moth is restricted by restrictor 119B positioned opposite sensing surface 121B when passing sensor surface 121B within channel 115B, has been observed to encourage the moth to pass across sensor surface 121B dorsally. This encouragement may be assisted by ramp-like surface 1192B of restrictor 119B, which surface the moth is encouraged to walk up towards sensor surface 121B. It has been observed that dorsal passage of the moth past sensor surface 121B can be advantageous for accurate moth identification.

Advantageously, combined exchangeable channel exit guide and restrictor component 118B of sensor device 100B allows for different sizes of restrictor 119B to be used with the same sensor device 100B. As discussed hereinabove and further below, restricting passage of arthropods or insects, such as moths, can be used to encourage characteristic behaviour useful to accurate pest identification. Combined exchangeable channel exit guide and restrictor component 118B advantageously allows for different sizes of restrictor 119B optimised for detection of particular arthropods or insects, such as moths, to be used with the same sensor device 100B.

Advantageously, exchangeable sensor 120B of sensor device 100B allows for different sensing surface 121B arrangements to be used with the same sensor device 100B. As discussed hereinabove and further below, particular sensing surface arrangements may be optimal or advantageous for identifying particular insect pests. Exchangeable sensor 120B advantageously allows for different sensors 120B optimised for detection of particular arthropods or insects, such as moths, to be used with the same sensor device 100B.

Without limitation, certain typical and alternative characteristics of aspects and embodiments of the invention are further described as follows.

Housing 110A/110B of sensor device 100A/100B is typically formed using wear-resilient materials, such as heavy-duty, weather resistant plastic, and/or rubber, and/or carbon or metal alloys such as stainless steel or aluminium alloys.

Receptacle device 200A/200B may be formed using less resilient materials, such as standard wearing or even disposable plastics. In some embodiments, compostable or otherwise biodegradable materials may be used for at least part of receptacle device 200A/200B.

As hereinabove described, channel 115A of sensor device 100A is a cylindrical channel about 15 mm in diameter, and sensing surface 121A of sensor device 100A is a ring-shaped sensing surface extending around cylindrical channel 115A. This arrangement has been found to be advantageous for encouraging and detecting behaviour by which certain large moths (such as FAW moths) can be identified, i.e. characteristic abdomen dragging, gliding, sliding, and/or hovering behaviour as described herein.

Similarly, the arrangement of channel 115B and sensing surface 121B of sensor device 100B as hereinabove described has been found to be advantageous for encouraging and detecting characteristic behaviour of certain large moths such as FAW moths. As hereinabove explained, the arrangement of channel 115B and sensing surface 121B may in some instances be particularly advantageous, as this arrangement can encourage arthropods or insects, such as moths, to pass across sensing surface 121B dorsally.

It will be appreciated that particular channel and/or sensor arrangements may be optimal or advantageous for identifying particular insect pests.

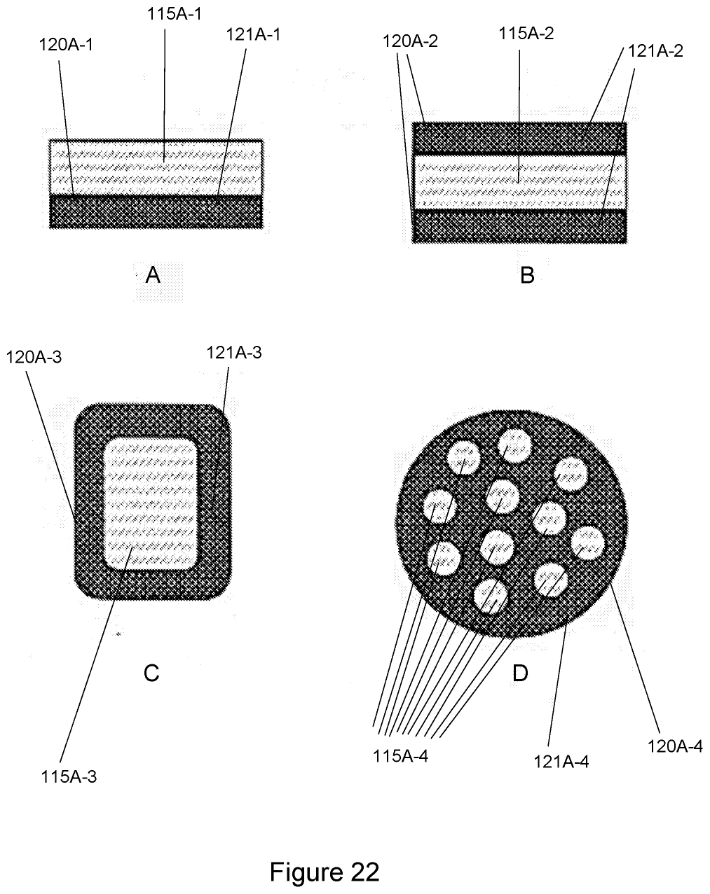

In the context of sensor device 100A, FIG. 22 sets forth certain non-limiting variations of channel and sensor arrangements.

In FIG. 22A, an arrangement comprising a horizontally elongated rectangular channel 115A-1 and a corresponding single lower rectangular sensor 120A-1 comprising sensing surface 121A-1 is shown. This arrangement may be advantageous for identifying patterns of lateral movement and/or expansion of wings along a lower edge of an exit channel, such as channel 115A-1, upon exit.

In FIG. 22B, an arrangement comprising a horizontally elongated rectangular channel 115A-2 and corresponding upper and lower rectangular sensors 120A-2 comprising sensing surfaces 121A-2 is shown. This arrangement may be advantageous for identifying patterns of both lateral and vertical movement and/or expansion of wings along lower and upper edges of an exit channel, such as channel 115A-2, upon exit.

In FIG. 22C, an arrangement comprising a vertically elongated rectangular channel 115A-3 fully surrounded by a corresponding rectangular sensor 120A-3 comprising sensing surface 121A-3 is shown. This arrangement may be advantageous for identifying patterns of movement such as body dragging that can occur around all sides of a rectangular exit channel, such as channel 115A-3, upon exit.

In FIG. 22D, an arrangement comprising a plurality of circular channels 115A-4 within a larger circular sensor 120A-4 comprising sensing surface 121A-4 is shown. This arrangement may be advantageous for identifying patterns of movement wherein an insect travels between a plurality of channels, such as channels 115C, prior to selecting a particular channel from which to exit.

By way of further non-limiting example, the sensor arrangements in FIGS. 22A, 22B, and 22C may be effective for identification of various Lepidoptera and/or Orthoptera insect pests having relatively large wingspan and a propensity to drag their abdomen and/or legs or tarsi across sensor components.

By way of further non-limiting example, the sensor arrangement in FIG. 22D may be effective for identification of various Drosophila and/or Carpophilus insect pests having a propensity of upward movement and a desire to enter small spaces, or for identification of various Lepidoptera, and/or Diptera insect pests having a propensity for inserting their ovipositor into small holes.

In the context of sensor device 100B, variations of sensing surface arrangements are discussed below with reference to FIGS. 45-46.

Further to the embodiment of FIG. 44, FIG. 45 shows another example of sensor 120B, referred to as sensor 120B-1. Sensor body 1200B-1 of sensor 120B-1 of is substantially the same as sensor body 1200B of sensor 120B. However, sensing surface 121B-1 comprises a different sensing arrangement as compared to that of sensing surface 121B. More particularly, whereas sensing surface 121B comprise upper and lower sensing arrangements comprising a broken bar bordered by unbroken bars, sensing surface 121B-1 comprises an upper sensing arrangement comprising a broken bar bordered by unbroken bars and a lower sensing arrangement comprising diamond banding.

With reference to FIG. 46, further embodiments of sensing surfaces 121B for sensor 120B are shown, referred to as 121B-2, 121B-3, 121B-4, 121B-5, 121B-6, 121B-7, and 121B-8. It will be appreciated that each of sensing surfaces 121B-2 to 121B-8 comprises a different sensing arrangement, the respective sensing arrangements incorporating various combinations of unbroken bars, broken bars, double and triple bar stacks, diamond bands, and stacked diamond bands.

Similarly as hereinabove described in relation to sensor variation in the context of sensor device 100A, the various sensing surface arrangements of 121B, 121B-1, 121B-2, 121B-3, 121B-4, 121B-5, 121B-6, 121B-7, and 121B-8 may be advantageous for sensing various arthropod or insect movements or patterns thereof and/or detecting various arthropods or insects in the context of sensor device 1001B.

As hereinabove noted, movement of at least certain arthropods or insects, such as moths, into or past a restricted channel or part thereof can be useful to encourage characteristic behaviour.

In the context of sensor device 100A, a sensor channel of about 15 mm diameter has been observed to be beneficial for detection of certain large moths such as FAW moths. However, it will be understood that the specific dimensions of the channel (or channels) may vary. In some typical embodiments, one or more dimensions of the one or more sensor channels, such as diameter, width, height, and length dimensions are between about 2 and about 50 mm, including 3, 4, 5, 6, 7, 8, 9, 10, 15, 20, 25, 30, 35, 40, and 45 mm.

In the context of sensor device 100B, as hereinabove described, channel restriction at the point of sensor detection can be adjusted using exchangeable channel exit guide and restrictor component 118B. In the embodiment of component 118B shown in FIG. 42C, the gap between the sensor and the restrictor is about 6.5 mm. The about 6.5 mm gap arrangement may be advantageous for particular arthropods or insects, or groups thereof, such as (by way of non-limiting example) Noctuid moths and Heteroptera bugs. In the embodiment of component 118B shown in FIG. 42D, the gap between the sensor and the restrictor is about 4.5 mm. The about 4.5 mm gap arrangement may be advantageous for particular arthropods or insects or, or groups thereof, such as (by way of non-limiting example) codling moth, diamondback moth, corn rootworm, and flies. More generally, restrictor component 119B and/or exchangeable channel exit guide and restrictor component 118B may be arranged to create a gap between the sensor and the restrictor of between about 1 mm and about 20 mm, including 2, 3, 4, 5, 6, 7, 8, 9, 10, 11, 12, 13, 14, 15, 16, 17, 18, and 19 mm.

It will be further understood that the particular location of insect entry and insect exit portions for device 1000A/1000B and receptacle device 200A/200B thereof can be varied. In some alternative embodiments, the entry portion may be at a lower or bottom portion or part of the receptacle device. In some alternative embodiments, the exit portion may be at an upper or side portion of the receptacle device. Generally, numerous variations are possible in relation to the location of the entry and exit portions of embodiments of the receptacle device, and the respective location of the sensor device and sensor thereof. Certain variations may be particularly desirable for detection and/or control of certain insects, either alone or in combination with sensor variations as herein described.

As herein described, device 1000A/1000B can be used in conjunction with computing equipment and software for insect pest monitoring, and potentially also monitoring of various other characteristics of or associated with device 1000A/1000B. In some typical embodiments, device 1000A/1000B is used in conjunction with mobile computing equipment such as a smartphone or tablet. Software for use in conjunction with device 1000A/1000B and mobile computing equipment may suitably be in app form, as will be readily understood by the skilled person.

An example of an app for use in conjunction with an existing insect monitoring device and mobile computing equipment is the RapidAIM app. Details of the existing insect monitoring device can be obtained from https://rapidaim.io/ and the download documents obtainable therefrom (including the RapidAIM Instruction Manual; the RapidAIM Quick Start Guide; and the RapidFLY Product Specifications) the entire contents of which is incorporated herein in full by reference. The RapidAIM app itself is obtainable from the Apple App Store at https://apps.apple.com/au/app/rapidaim/id1493365634 and incorporated herein in full by reference.

In conjunction with the existing insect monitoring device and a mobile computing device, as at the priority date, the RapidAIM app is primarily for use in monitoring of fruit fly (e.g. Bactrocera tryoni). However, it will be appreciated that similar principles can be applied for monitoring of insects using device 1000A/1000B as described herein using mobile computing equipment.

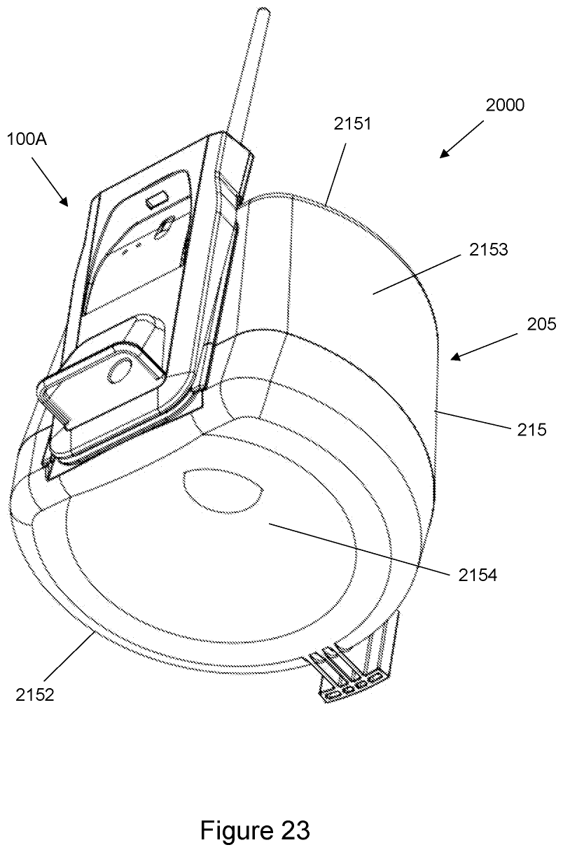

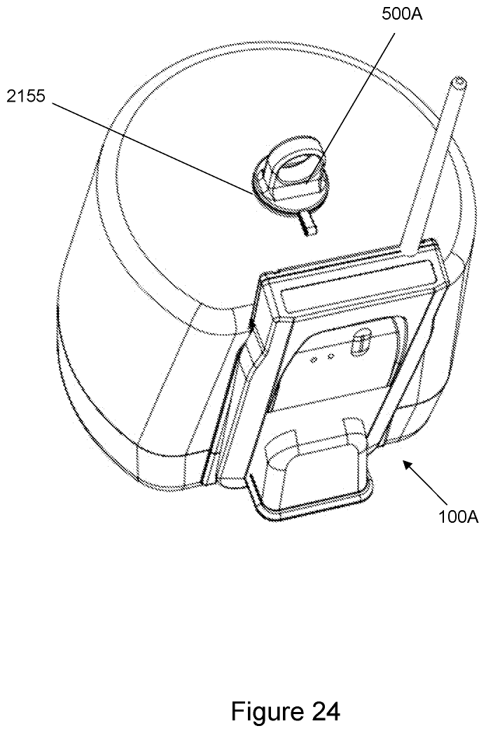

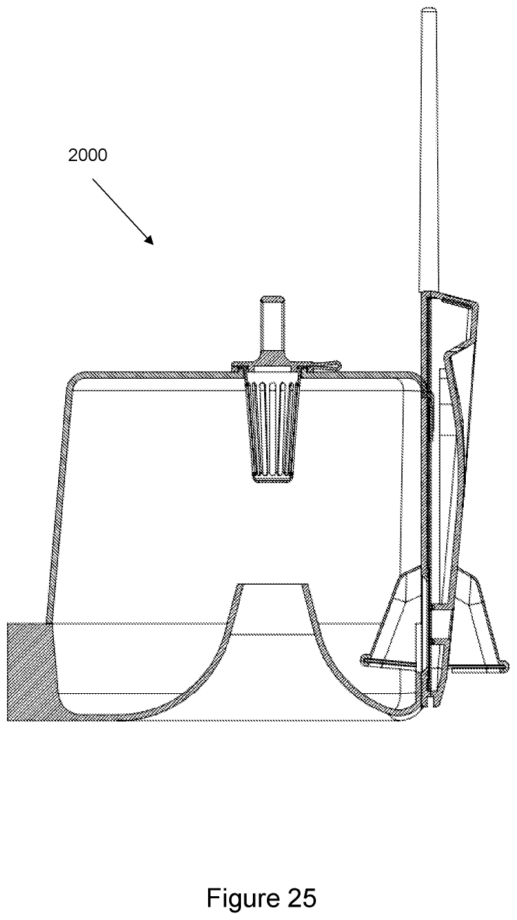

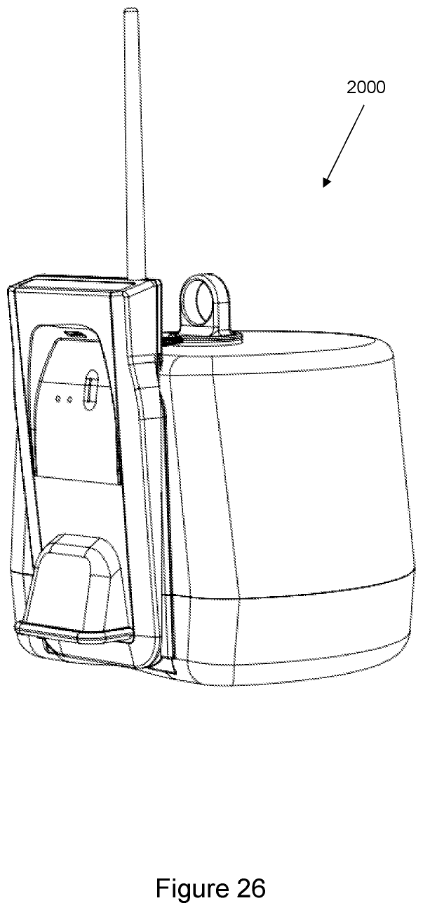

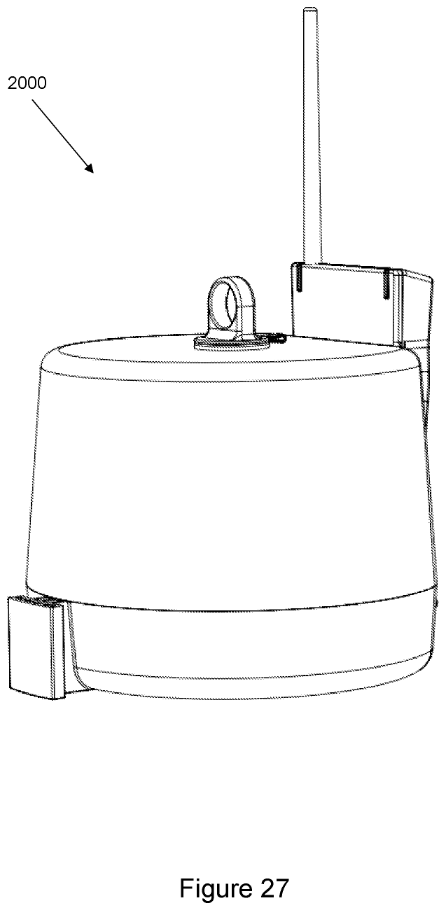

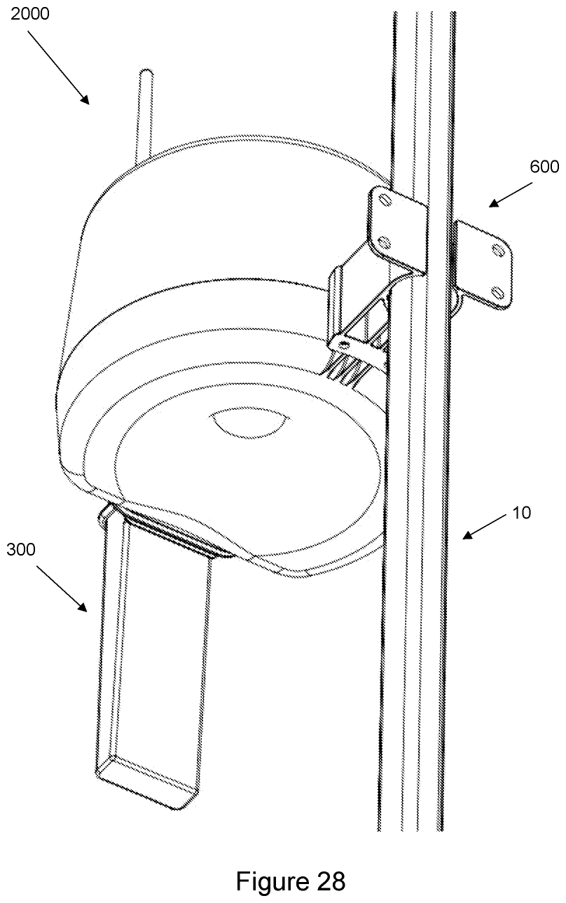

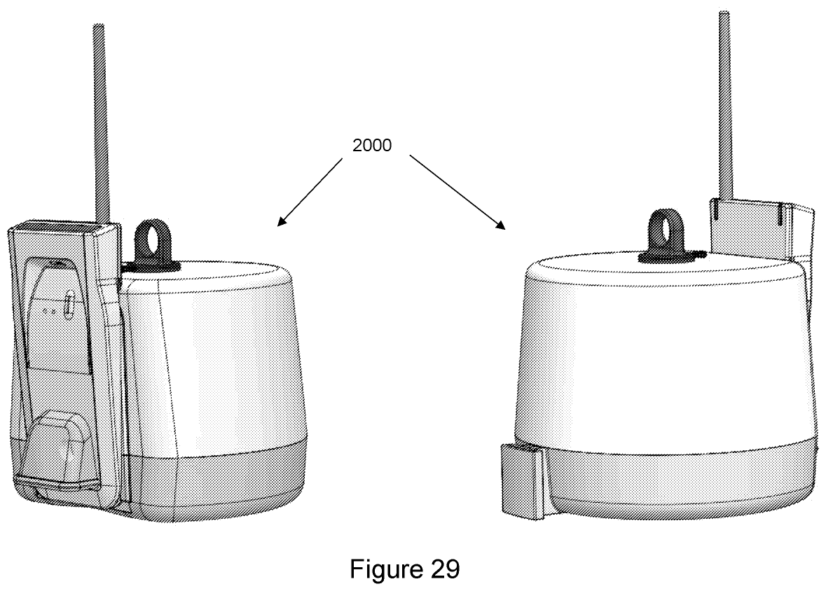

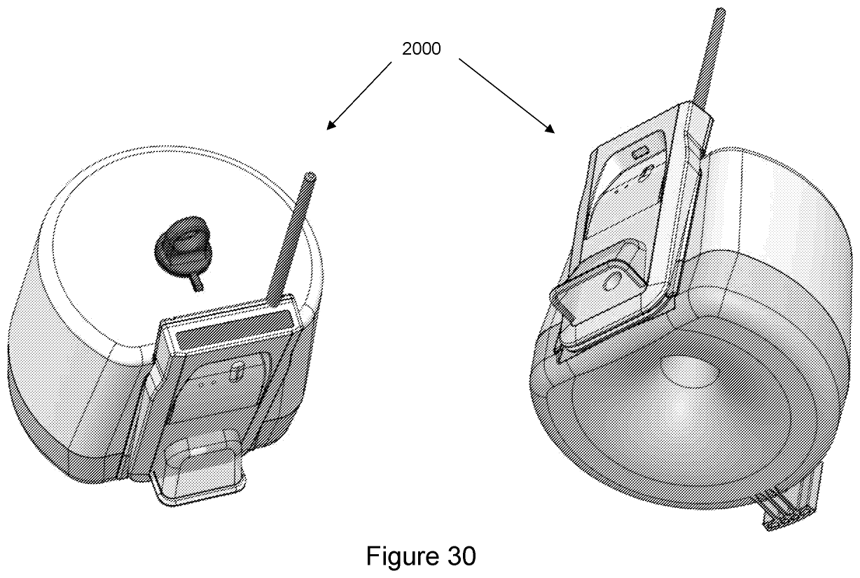

As set out above, the modular relationship of receptacle device 200A/200B and sensor device 100A/100B can advantageously allow for use of various embodiments receptacle devices with the same sensor device 100A/100B, to facilitate optimised detection of different insects. An example in this respect is provided as follows with reference to FIGS. 23-30.

FIGS. 23-30 illustrate another embodiment of a device for monitoring and controlling insect pests, device 2000. Device 2000 is adapted for monitoring and controlling pest beetles, such as pest beetles of the genus Diabrotica. Device 2000 is particularly adapted for monitoring and controlling corn rootworm (CRW), although without limitation thereto.

Device 2000 comprises sensor device 100A as hereinabove described; and a first receptacle component in the form of receptacle device 205. Device 2000 further comprises second receptacle 300A; attractant holder 500A; and mount 600A as hereinabove described.

It will be appreciated that, for device 2000, the same sensor device 100A is used with a different embodiment of receptacle device, i.e. receptacle device 205, to facilitate optimised monitoring of a different insect, i.e. CRW.

Upon comparison of FIGS. 1-19 and FIGS. 23-30, it will be appreciated that receptacle device 205 is inverted relative to receptacle device 200A. With this in mind, similarly to receptacle device 200A, receptacle device 205 of device 2000 comprises receptacle body 215, which is a substantially hollow body comprising receptacle body top 2151; receptacle body bottom 2152; and receptacle body side wall 2153 extending between top 2151 and bottom 2152.

The primary difference between receptacle device 205 and receptacle device 200A is that, for receptacle device 205, centrally located funnel-like insect entry portion 2154 is of receptacle body bottom 2152. Additionally, unlike receptacle device 200A, receptacle device 205 does not include lid 400A, and attractant holder 500A is inserted into aperture 2155 of receptacle body top 2151.

Use of device 2000 is similar as herein described for device 1000, with the notable difference that insects, typically CRW beetles, enter receptacle device 205 by climbing up into insect entry portion 2154.

Advantages of device 2000 are similar as herein described for device 1000A, with the notable difference that device 2000 is optimised for monitoring of CRW beetles rather than FAW moths.

It will be appreciated that sensor device 100B could be used in a similar arrangement as described above in relation to device 2000 and device 100A.

To avoid doubt, it will be appreciated that aspects and embodiments of the present invention have applications extending far beyond monitoring of FAW moths or CRW beetles. The skilled person will readily appreciate that variations in design as discussed herein, including sensor design, channel design and/or restriction thereof, and/or receptacle design, can facilitate monitoring of a broad range of arthropods and insect pests. By way of non-limiting example, aspects and embodiments of the present invention may be suitable or advantageous for detection and/or control of insect pests of the orders Lepidoptera, Coleoptera, Hemiptera and Diptera. Aspects and embodiments of the present invention may be suitable or advantageous for detection and/or control of moths of the Noctuidae, including of the genera Spodoptera, Heliothis, Helicoverpa; moths of the Crambidae, including of the genera Scirpophaga and Ostrinia; moths of the Pyralidae and Torticidae, including of the genera Cydia, Lobesia and Amyelois; moths of the Plutellidae, including of the genus Plutella; beetles of the Chryosmelidae, including of the genus Diabrotica; beetles of the Scarabaeidae, including of the genus Popillia; true bugs of the Pentatomidae, including of the genera Halyomorpha, Nezara, Amblypelta; flies of the Tephritidae, including of the genera Bactrocera and Ceratitis; and flies of the Calliphoridae and Muscidae, including of the genera Lucilia, Calliphora, and Haematobia.

It is noted that International Publication Number WO2018/068092 contains extensive discussion of various insect behavioural patterns and corresponding sensor designs. This information, incorporated herein, is a useful reference for the skilled person when considering sensor and/or receptacle variations. It is noted, by way of example, that WO2018/068092 sets out various movements of arthropods and insects that can be detected by sensing surface of sensors, including walking on the sensing surface with tarsi of the arthropod; dragging on the sensing surface with an abdomen of the arthropod; palping on the sensing surface with a mouthpart of the arthropod; drumming on the sensing surface with antennae of the arthropod; and ovipositing on the sensing surface with an ovipositor of the arthropod.

While aspects and embodiments of the invention have been described with primary reference to sensors that are electronic capacitance sensors, such as sensors as described in International Publication Number WO2018/068092, the invention is not so limited, and the use of other sensor types may be used together with or even in place of electronic capacitance sensors. By way of non-limiting example, camera-based sensors, acoustic sensors, and/or light-based sensors such as infrared sensors or the like may be used.

It is noted that International Publication Number WO2012/054990 contains extensive detail and discussion of the use of certain camera-based sensor designs in the context of insect detection. International Publication Number WO2012/054990, incorporated herein in full by reference, is a useful reference for the skilled person when considering sensor variations.

It is further noted that, while the use of environmental sensors in the form of temperature and humidity sensors has been described in detail herein, any other suitable environmental and/or climatic sensors may also be included, e.g. as PCB sensors or the like.

Additionally, while aspects and embodiments of the invention involving communication between devices as described herein and computing equipment such as mobile computing devices and servers have been described with primary reference to wireless communication, it will be appreciated that wired communication may also be used. By way of non-limiting example, devices may be hard wired in connection with computing equipment in situ, such as in grain silos or other storage areas.

It will be understood generally that the above description of embodiments of the invention is provided for purposes of description to one of ordinary skill in the related art. It is not intended to be exhaustive or to limit the invention to a single disclosed embodiment. In some instances, well-known components and/or processes have not been described in detail, so as not to obscure the embodiments described herein.

As described, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations that have been discussed herein, and other embodiments that fall within the spirit and scope of the invention.

In this specification, the use of the terms “suitable” and “suitably”, and similar terms, is not to be read as implying that a feature or step is essential, although such features or steps referred to as “suitable” may well be preferred.

In this specification, the indefinite articles “a” and “an” are not to be read as singular indefinite articles or as otherwise excluding more than one or more than a single subject to which the indefinite article refers. For example, “a” sensor includes one sensor, one or more sensors, and a plurality of sensors.

In this specification, the terms “comprises”, “comprising”, “includes”, “including”, and similar terms, are intended to denote the inclusion of a stated integer or integers, but not necessarily the exclusion of another integer or other integers, depending on context. That is, a product, composition, or method, etc., that comprises or includes stated integer(s) need not have those integer(s) solely, and may well have at least some other integers not stated, depending on context.

In this specification, the terms “consisting essentially of” and “consists essentially of” are intended to mean a non-exclusive inclusion only to the extent that, if additional elements are included beyond those elements recited, the additional elements do not materially alter basic and novel characteristics. That is, an apparatus, system, or method that “consists essentially of” one or more recited elements includes those elements only, or those elements and any additional elements that do not materially alter the basic and novel characteristics of the apparatus, system, or method.

In this specification, terms such as “above” and “below”; “front” and “back”; “top” and “bottom”; “left” and “right”; “horizontal” and “vertical”, and the like, may be used for descriptive purposes. However, it will be understood that embodiments can potentially be arranged in various orientations, and that such relative terms are not limiting and may be interchangeable in appropriate circumstances.

In this specification, unless the context requires otherwise, the terms “connection”, “connected”, “connecting”, and the like, are not to be read as limited to direct connections and may also include indirect connections. For example, unless the context requires otherwise, a stated first component “connected” to a stated second component may be connected via, through, or by, one or more unstated components.

1. A method of detecting an insect, the method including steps of allowing the insect to enter a first receptacle; sensing a movement of the insect with a sensor; and allowing the insect to leave the first receptacle, wherein the step of sensing movement of the insect includes sensing movement of the insect directly before or during exit of the receptacle.

2. The method of claim 1, wherein the insect is an insect pest-selected from the group consisting of: an agricultural insect pest: a pest of a vegetable crop, a fruit crop, a grain crop, a fibre crop, or a cereal crop; and a pest of an ungulate animal or a poultry animal.

3. (canceled)

4. (canceled)

5. (canceled)

6. (canceled)

7. The method of claim 1, wherein the insect is selected from the group consisting of a moth, a beetle, a true bug, and a fly.

8. (canceled)

9. (canceled)

10. The method of claim 1, wherein the movement of the insect sensed by the sensor is movement of the insect's thorax or abdomen.

11. (canceled)

12. (canceled)

13. The method of claim 1, including a step of controlling the insect by contact of the insect with a control agent located within the first receptacle.

14. The method of claim 13, wherein the control agent is a biocontrol agent.

15. (canceled)

16. The method of claim 13, including a step of controlling a population of insects by contacting the population of insects with the insect contacted by the biocontrol agent.

17. (canceled)

18. (canceled)

19. The method of claim 1, wherein the sensor with which movement of the insect is sensed is a capacitance sensor.

20. The method of claim 1, wherein the sensor with which movement of the insect is sensed is an exchangeable sensor.

21. The method of claim 1, wherein the sensor with which movement of the insect is sensed is of an electronic device connected to the first receptacle.

22. (canceled)

23. The method of claim 1, including a step of transmitting information on detection of the insect to a computing device and/or database.

24. (canceled)

25. A device comprising a housing and an insect sensor connected to the housing, wherein the device is adapted for attachment with a receptacle to sense movement of an insect out of the receptacle.

26. The device of claim 25, wherein the sensor is selected from the group consisting of an electronic sensor; a capacitance sensor; and a printed circuit board sensor.

27. (canceled)

28. (canceled)

29. The device of claim 25, wherein the sensor is an exchangeable sensor.

30. (canceled)

31. The device of claim 25, wherein the housing comprises a channel for allowing passage of the insect therethrough, and wherein the housing comprises or is connectable with a restrictor for restricting the channel.

32. (canceled)

33. The device of claim 31, wherein the restrictor is for restricting the channel at or near a position of the insect sensor.

34. The device of claim 33, wherein the restrictor is an exchangeable restrictor.

35. (canceled)

36. (canceled)

37. (canceled)

38. The device of claim 25, comprising a power source comprising one or more of a lithium-ion battery; a photovoltaic cell; a processor; a data transmitter; and a data receiver.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. The method of claim 1, wherein the step of sensing movement of the insect with the sensor includes sensing movement of the insect associated with passage of the insect through a restricted space.

51. The method of claim 1, including a step of identifying the insect and/or estimating population characteristics of the insect based on information including the sensed movement of the insect.
